(19) United States
(12) Patent Application Publication
(10) Pub. No.: US 2005/0149217 A1
(43) Pub. Date: Jul. 7, 2005

(54) Semiconductor manufacturing system, work manufacturing system, and conveyance system

(75) Inventors: Yoshio Okada, Sendai (JP); Takayuki Wakabayashi, Kodaira (JP); Atsuyoshi Koike, Kunitachi (JP); Naoki Takehara, Hitachinaka (JP)

Correspondence Address: Stanley P. Fisher;Reed Smith LLP, Suite 1400, 3110 Fairview Park Drive, Falls Church, VA, 22042-0681, US

(73) Assignee: Trecenti Technologies, Inc.

(21) Appl. No.: 11/030,154

(22) Filed: Jan. 7, 2005

(30) Foreign Application Priority Data
Jan. 8, 2004 (JP) P2004-003269
Jan. 8, 2004 (JP) P2004-002851
Jan. 7, 2004 (JP) P2004-001814

(51) Int. Cl. G06F 19/00

(52) U.S. Cl. 700/96; 700/99

(57) ABSTRACT

A semiconductor manufacturing system in a clean room is composed of a combination of a flow shop section and a job shop section. The flow shop section is composed of a quasi flow shop section and a quasi job shop section. In the quasi flow shop section, manufacturing apparatuses are arranged respectively so that a difference between processing ability of the manufacturing apparatuses is taken into consideration and a balance in productivity is achieved. In the quasi job shop section, manufacturing apparatuses are arranged respectively so that the balance in productivity is not achieved due to low or high processing ability of the manufacturing apparatuses, and are provided so as to be shared by the quasi flow shop section. Accordingly, a difference between the processing ability of the manufacturing apparatuses can be reduced and the cycle time can be significantly reduced.

### CROSS-REFERENCE TO RELATED APPLICATION

The present application claims priority from Japanese patent application No. JP 2004-001814 filed on Jan. 7, 2004 and Nos. JP 2004-003269 and JP 2004-002851 filed on Jan. 8, 2004, the contents of which are hereby incorporated by reference into this application.

### BACKGROUND OF THE INVENTION

The present invention relates to a technique for manufacturing a semiconductor device, and particularly to a technique effectively applied to improvement of a cycle time in semiconductor device manufacture, improvement in productivity of the semiconductor device manufacture, and transfer of employing a flow shop system layout in a transfer system which improves logistics in a flow shop layout in which a plurality of manufacturing apparatuses (or tools or a plurality of pieces of equipment) are disposed (or laid out or arranged) along flow of a process.

A manufacturing technique in a manufacturing process of the semiconductor device includes, for example, a technique in which a flow shop-installed unit and a job shop-installed unit are disposed in combination in a clean room in order to improve productivity of the semiconductor devices (Japanese Patent Laid-Open No, 11-145022); and a technique in which a flow shop-installed unit for repeating the same processing steps is disposed and further a job shop-installed unit employed for a flow shop system, in which a plurality of process facilities are integrally disposed so as to regard a work transfer path as their center, is disposed (Japanese Patent Laid-Open No. 2002-26106).

The “Job shop” is a layout method of manufacturing apparatuses in which a group of manufacturing apparatuses having the same kind of functions is collectively disposed, and the “flow shop” is a layout method in which the manufacturing apparatuses are sequentially disposed so as to correspond to flow of manufacturing steps.

Also, a manufacturing technique for the semiconductor devices in a manufacturing process includes, for example, a technique in which, in order to improve productivity of the semiconductor device manufacture, a flow shop-installed unit in which manufacturing apparatuses are sequentially disposed so as to correspond to the order of manufacturing steps and a job shop-installed unit in which a group of manufacturing apparatuses having the same kind of functions are collectively disposed are combined in a clean room (Japanese Patent Laid-Open No. 11-145022).

In addition, a system control technique of manufacturing apparatuses disposed by a flow shop layout includes, for example, a technique in which flow shop lines including a plurality of processing apparatuses and a transfer system are recognized and controlled as one manufacturing apparatus (Japanese Patent Laid-Open No. 2001-143979).

According to examinations by the present inventors, the following technique is conceivable as a conventional transfer system.

For example, in a transfer system employed for a flow shop system layout, a plurality of manufacturing apparatuses are disposed along the flow of the process in a flow shop area, and a transfer system which drives in parallel to the manufacturing apparatuses is provided. Meanwhile, a job shop system layout, in which a plurality of manufacturing apparatuses are disposed based on functions of the process, is also employed, so that in a semiconductor manufacturing system, plants employing a layout having a combination of the job shop system and the flow shop system have been built.

Note that such a transfer system includes, for example, techniques described in Japanese Patent Laid-Open Nos. 3-264245, 11-145022, and No. 0.2002-26106.

Japanese Patent Laid-Open No. 3-264245 discloses a technique which employs a combination of a job shop system and a flow shop system. Japanese Patent Laid-Open No. 11-145022 discloses a technique relating to a method of laying out a job shop area and a flow shop area and a connection method of a transfer route. Japanese Patent Laid-Open No. 2002-26106 discloses a technique, in which a job shop area is laid out in the flow shop area.

### SUMMARY OF THE INVENTION

However, the present inventors have found out that the above-described techniques for manufacturing semiconductor devices have the following problems.

Since the respective manufacturing apparatuses disposed in the flow shop are different from one another in terms of a process time, maintenance frequency, failure frequency, and a repair time, and so on, productivity of each step thereof is off-balanced due to influences by the above factors. This may cause stagnation in the semiconductor manufacture.

Therefore, overall utilization of the manufacturing apparatuses is lowered, whereby there is a possibility that investment efficiency will deteriorate.

Meanwhile, in the transfer system employed for the flow shop system layout, if only a process along one flow is executed, wafers are transferred in the one direction through each of the sequentially disposed manufacturing apparatuses subsequently through the process flow. However, in a practical semiconductor manufacturing line, a plurality of similar flows have to be processed in the same flow shop area. In this case, even in the flow shop area, the manufacturing apparatuses cannot be disposed along the process flows so that wafers are not transferred in the one direction, but forward and backward. In the conventional semiconductor manufacturing lines, a flow shop system is designed for the plurality of similar process flows for a plurality of different types of product classes. Therefore, for the conventional semiconductor manufacture, an efficient transfer system in which one-directional flow is premised has not been proposed.

Further, when any trouble occurs in the manufacturing apparatus within one flow shop area, a manufacturing apparatus in other flow shop area is required to be temporarily used as a substitute apparatus. At this time, if a short transfer path between the flow shop areas is provided, a production cycle time can be reduced.

In the above-described Japanese Patent Laid-Open Nos. 3-264245, 11-145022, and 2002-26106, connection of a transfer route between the flow shop area and the job shop area is described. However, the description thereof does not constitute a technique for shortening the transfer time among the flow shop areas.

Also, in the conventional techniques, an inter-bay transfer path can be used as a transfer method among flow shop areas. However, when a transfer route covering the entire plant is used to support transfer among the flow shop areas, where trouble occurs, the transfer cannot always be performed in the shortest route. Also, it is conceivable that a load on inter-bay transfer temporarily increases so as to cause deterioration of overall transfer efficiency (transfer capability and transfer time) in the entire plant. Thus far, there has not been provided a technique for performing efficient transfer among the flow shop areas in order to execute backup at a time of the trouble or to temporarily complement capability of the apparatus in a plant aiming at shortening of the transfer time as much as possible for shortening a cycle time of products.

An object of the present invention is to provide a technique, which can prevent stagnation in the semiconductor device manufacture performed in the flow shop and significantly improve productivity of semiconductor devices.

Another object of the present invention is to provide a transfer technique that can shorten the cycle time of products by shortening a transfer time of products and by shortening a wait time of a guided vehicle, in order to realize efficient transfer in a transfer system employed for a flow shop system layout.

The above and other objects and novel features of the invention will become apparent from the description of the specification and the accompanying drawings.

Outlines of representative ones of the inventions disclosed in the present application will be briefly described as follows.

The present invention is a semiconductor manufacturing system having a job shop section in which a group of manufacturing apparatuses with the same functions is disposed, and a flow shop section in which manufacturing apparatuses are sequentially disposed so as to correspond to process flow of manufacturing a semiconductor device. The flow shop section is composed of a quasi flow shop and a quasi job shop. The quasi flow shop section in which the manufacturing apparatuses having almost the same level to a production balance condition of semiconductor manufacture are disposed approximately in order of the manufacturing steps: and a quasi job shop section in which the manufacturing apparatuses, which are not included in a quasi flow shop section among the manufacturing apparatuses disposed in the flow shop section, are disposed.

Also, the present invention is a work manufacturing system comprising: a job shop area in which a group of manufacturing apparatuses with the same function is disposed; and a flow shop area in which a plurality of manufacturing apparatuses are sequentially disposed so as to correspond to order of manufacturing steps of a work, wherein the flow shop area includes; a quasi flow shop area in which manufacturing apparatuses having almost the same level to a production balance condition of work manufacture are disposed approximately in order of manufacturing steps; and a quasi job shop area in which the manufacturing apparatuses, which are not included in the quasi flow shop area among the manufacturing apparatuses disposed in the flow shop area, are disposed.

Further, the present invention is a work manufacturing system comprising: a first manufacturing area in which a group of manufacturing apparatuses having the same function is disposed; and a second manufacturing area in which a plurality of manufacturing apparatuses are subsequently disposed so as to correspond to order of manufacturing steps of a work, wherein the second manufacturing area includes: a first apparatus set area in which manufacturing apparatuses having almost the same level to a production balance condition of work manufacture are sequentially disposed approximately in order of manufacturing steps: and a second apparatus set area In which the manufacturing apparatuses, which are not included in the first apparatus set area among the manufacturing apparatuses disposed in the second manufacturing area, are sequentially disposed in order of the manufacturing steps.

Also, the present invention is a semiconductor manufacturing system comprising; a job shop in which a group of manufacturing apparatuses having the same function is disposed: and a flow shop in which manufacturing apparatuses are sequentially disposed so as to correspond to process flow of manufacturing a semiconductor device, wherein the flow shop includes: a quasi flow shop in which manufacturing apparatuses having the same level to a production balance condition of semiconductor manufacture are disposed approximately in order of manufacturing steps; and a quasi job shop in which the manufacturing apparatuses, which are not included in the quasi flow shop among the manufacturing apparatuses disposed in the flow shop, are disposed. Also, the quasi flow shop includes: two or more cells, each of which is composed of a manufacturing apparatus serving as a minimum unit required in a semiconductor manufacturing step; and each cell is equipped with a manufacture management means (or manufacture management subsystem) for managing the cell as an independent manufacturing line.

In addition, outlines of the other invention disclosed in the present application will be briefly described as follows.

The present invention is a work manufacturing system comprising: a job shop in which a group of manufacturing apparatuses having the same function is disposed; and a flow shop in which manufacturing apparatuses are sequentially disposed so as to correspond to order of steps of manufacturing a work, wherein the flow shop includes: a quasi flow shop in which the manufacturing apparatuses having almost the same level to a production balance condition of work manufacture are disposed approximately in order of manufacturing steps; and a quasi job shop in which the manufacturing apparatuses, which are not included in the quasi flow shop among the manufacturing apparatuses disposed in the flow shop, are disposed, and wherein the quasi flow shop includes: two or more cells, each of which is divided per manufacturing apparatus serving as a minimum unit required in the work manufacturing step. And, each cell is equipped with a manufacture management means (or manufacturing management system) for managing each of the cells as an independent manufacturing line.

Also, the present invention is a transfer system comprising: a flow shop area in which a plurality of manufacturing apparatuses are arranged along a process flow; and a guided vehicle for conveying a product between the plurality of manufacturing apparatuses in the flow shop area, wherein the guided vehicle has a driving wheel set at a rear-wheel side and a decelerator set at a front-wheel side with respect to a transfer direction of the product.

Further, the present invention is a transfer system comprising: a flow shop area in which a plurality of manufacturing apparatuses are disposed along a process flow: and a guided vehicle for conveying a product between the plurality of manufacturing apparatuses in the flow shop area, wherein the guided vehicle is placed in a standby condition at a upstream portion with respect to a transfer direction of the product.

Also, the present invention is a transfer system comprising: a flow shop area in which a plurality of manufacturing apparatuses are disposed along a process flow; and a plurality of guided vehicles for conveying a product between the plurality of manufacturing apparatuses in the flow shop area, wherein the plurality of guided vehicles move on one rail and are placed in standby conditions at a upstream portion in a transfer direction of the product.

Further, the present invention is a transfer system comprising: a flow shop area in which a plurality of manufacturing apparatuses are disposed along a process flow; and a guided vehicle for conveying a product between the plurality of manufacturing apparatuses in the flow shop area, wherein the guided vehicle is capable of conveying a plurality of products, and conveying a second product as well as a first product during transfer of the first product.

Also, the present invention is a transfer system comprising: a flow shop area in which a plurality of manufacturing apparatuses are disposed along a process flow: and a guided vehicle for conveying a product between the plurality of manufacturing apparatuses in the flow shop area, wherein the flow shop area is divided into a cell area composed of a group of manufacturing apparatuses serving as a minimum unit required in a step. A shelf is provided for temporarily keeping the product in the cell area, near a currently used manufacturing apparatus and a manufacturing apparatus used in a next step. When the product cannot be conveyed from the currently used manufacturing apparatus to the manufacturing apparatus used in the next step, the product is stored in a shelf.

Further, the present invention is a transfer system comprising: a flow shop area in which a plurality of manufacturing apparatuses are disposed along a process flow; and a guided vehicle for conveying a product between the plurality of manufacturing apparatuses in the flow shop area, wherein the flow shop area is divided into a plurality of cell areas, each of which is composed of a group of manufacturing apparatuses serving as a minimum unit required in a step, and a transfer path for conveying the product is provided among the plurality of cell areas.

Effects obtained from representative ones of the inventions disclosed in the present application will be briefly described as follows.

(1) Since a utilization rate of each of the manufacturing apparatuses in a flow shop section can be improved, production efficiency in the semiconductor manufacturing steps can be significantly improved.

(2) By controlling each cell in the quasi flow shop as an independent manufacture line, productivity of the semiconductor devices can be significantly improved.

(3) The transfer time of the products can be shortened.

(4) The wait time of the guided vehicle can be shortened.

(5) By virtue of items (3) and (4), the cycle time of products can be shortened.

### BRIEF DESCRIPTION OF THE DRAWINGS

FIG. 1 is a block diagram showing an arrangement of a semiconductor manufacturing system according to a first embodiment of the present invention.

FIG. 2 is a layout diagram showing one example of a manufacturing apparatus by a flow shop in the semiconductor manufacturing system of FIG. 1.

FIG. 3 is a layout diagram showing another example of the manufacturing apparatus by the flow shop of the semiconductor manufacturing system of FIG. 1.

FIG. 4 is a block diagram showing an arrangement at a time of dividing a quasi flow shop section of the semiconductor manufacturing system of FIG. 1.

FIG. 5 is a layout diagram showing one example of the manufacturing apparatus by the quasi flow shop section of FIG. 4.

FIG. 6 is a layout diagram showing another example of the manufacturing apparatus by the quasi flow shop section of FIG. 4.

FIG. 7 is a layout diagram showing still another arrangement of the manufacturing apparatus by the quasi flow shop section of FIG. 4.

FIG. 8 is a layout diagram showing still another arrangement of the manufacturing apparatus by the quasi flow shop section of FIG. 4.

FIG. 9 is a block diagram of a semiconductor manufacturing control system according to a second embodiment of the present invention.

FIG. 10 is a flow chart showing an operation example in the semiconductor manufacturing control system of FIG. 9.

FIG. 11 is a flow chart subsequent to that of FIG. 10.

FIG. 12 is a flow chart showing one example of an inquiry process of the semiconductor manufacturing control system of FIG. 9.

FIG. 13 is a flow chart at a time of limiting a worker of each cell in the semiconductor manufacturing control system of FIG. 9.

FIG. 14 is a block diagram showing one example of a transfer system according a third embodiment of the present invention.

FIG. 15 is a block diagram showing one example of a transfer system according to a fourth embodiment of the present invention.

FIG. 16 is a block diagram showing one example of a transfer system according to a fifth embodiment of the present invention.

FIG. 17 is a block diagram showing one example of a transfer system according to a sixth embodiment of the present invention.

FIG. 18 is a block diagram showing one example of a transfer system according to a seventh embodiment of the present invention.

FIG. 19 is a block diagram showing one example of a transfer system according to an eighth embodiment of the present invention,

FIG. 20 is a block diagram showing one example of a transfer system according to a ninth embodiment of the present invention.

FIG. 21 is a block diagram showing one example of a transfer system according to a tenth embodiment of the present invention.

### DESCRIPTION OF THE PREFERRED EMBODIMENTS

### First Embodiment

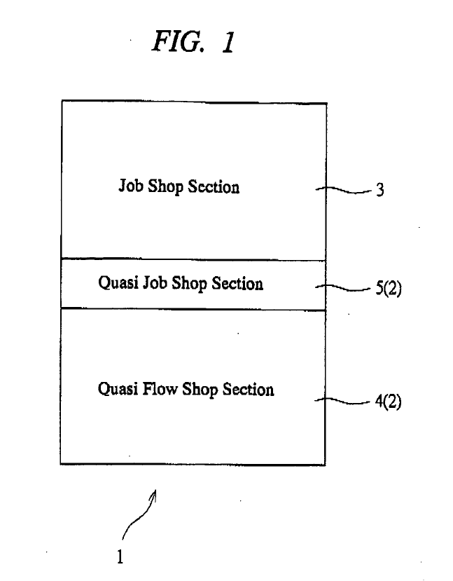

In a present first embodiment, a semiconductor manufacturing system 1 in a clean room comprises, for example, manufacturing apparatuses used in a transistor formation process etc. As shown in FIG. 1, the semiconductor manufacturing system 1 comprises a combination of a flow shop section 2 and a job shop section 3, wherein the flow shop section 2 is disposed on a lower side of FIG. 1 and the job shop section 3 is disposed on the top of the flow shop section 2.

The flow shop section 2 is an area in which the manufacturing apparatuses are sequentially disposed so as to correspond to process flow of manufacturing steps. In the section, manufacturing apparatuses used in a frequently repeated manufacturing step such as an ion implantation step and/or a wiring step (a Cu (copper) damascene step and an Al (aluminum) wiring step) are disposed.

In the job shop section 3, apparatuses such as a cleaning apparatus, an oxidation apparatus, a diffusion apparatus, an LPCVD apparatus, an etching apparatus, an ion implantation apparatus, a lithography apparatus, and an inspection apparatus are disposed so as to be collected as a group of apparatus with the same function(s), and manufacturing steps other than those processed in the flow shop section 2 are processed.

The flow shop section 2 is composed of a quasi (or pseudo) flow shop section 4 and a quasi job shop section 5. In FIG. 1, the quasi job shop section 5 is disposed below the job shop section 3, and the quasi flow shop section 4 is disposed below the quasi job shop section 5.

In the quasi flow shop section 4, the manufacturing apparatuses are disposed such that a difference in processing ability (production balance condition) of the manufacturing apparatuses is taken into consideration and a balance in productivity can be achieved. In the quasi job shop section 5, there are disposed such manufacturing apparatuses that a balance in productivity is not achieved due to their low or high processing ability etc., and the manufacturing apparatuses are provided so as to be shared by the quasi flow shop section 4.

FIG. 1 illustrates such a configuration that the quasi job shop section 5 is provided between the job shop section 3 and the quasi flow shop section 4. However, the quasi job shop section 5 may be provided below the quasi flow shop section 4.

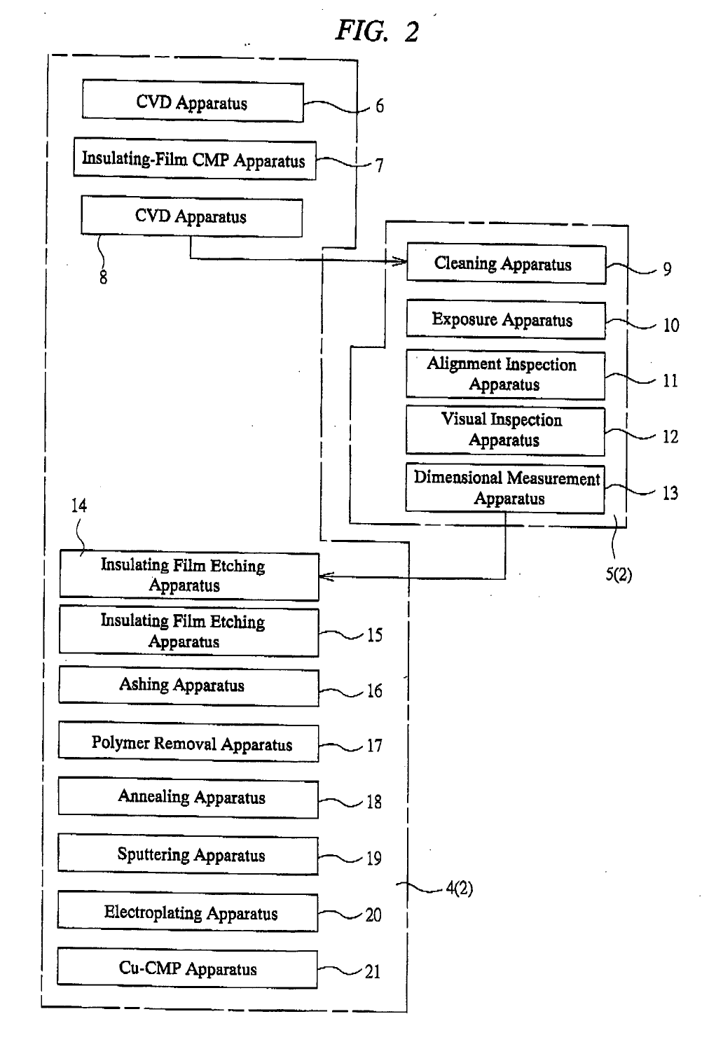

FIG. 2 is a diagram showing one example of the manufacturing apparatuses laid out in the flow shop section 2 in a wiring step. The manufacturing apparatuses shown in FIG. 2 represent one example, and the manufacturing apparatuses employed in the flow shop section 2 are not limited to the above example.

As shown in the Figure, in the flow shop section 2, for example, a CVD (Chemical Vapor Deposition) apparatus 6, an insulating-film CMP (Chemical Mechanical Polishing) apparatus 7, a CVD apparatus 8, a cleaning apparatus 9, an exposure apparatus 10, an alignment inspection apparatus 11, a visual inspection apparatus 12, a dimensional measurement apparatus 13, an insulating film etching apparatuses 14 and 15, an ashing apparatus 16, a polymer removal apparatus 17, an annealing apparatus 18, a sputtering apparatus 19, an electroplating apparatus 20, and a Cu-CMP apparatus 21 are provided.

Each of the CVD apparatuses 6 and 8 supplies a compound gas or a single-component gas composed of an element(s) composing a thin film material to semiconductor wafers and, through a chemical reaction caused in a gas phase or on the surface of semiconductor wafers, forms a desired thin film. The insulating-film CMP apparatus 7 planarizes an interlayer dielectric film.

The cleaning apparatus 9 performs cleaning of the semiconductor wafers. The exposure apparatus 10 exposes mask patterns to the semiconductor wafers. The alignment inspection apparatus 11 inspects alignment of the exposed patterns. The visual inspection apparatus 12 inspects defects etc. in the mask patterns.

The dimensional measurement apparatus 13 measures the dimensions of the patterns etc. formed on the semiconductor wafers. The insulating-film etching apparatuses 14 and 15 etch insulating films formed on the surfaces of the semiconductor wafers. The ashing apparatus 16 performs an ashing process to a resist on the semiconductor wafers. The polymer removal apparatus 17 removes unnecessary polymer films from the semiconductor wafers.

The annealing apparatus 18 performs a heat treatment to the thin films on the semiconductor wafers. The sputtering apparatus 19 forms thin films, which serve as barrier conductive films and seed films for plating in wiring layers, by means of sputtering phenomenon. The electroplating apparatus 20 performs electroplating of Cu as a material of wirings. The Cu-CMP apparatus 21 planarizes the wiring layers.

These manufacturing apparatuses are disposed approximately in order of the manufacturing processes, and when the manufacturing steps in the flow shop section 2 are repeated, wirings are formed on the semiconductor wafers.

Among these manufacturing apparatuses, the CVD apparatus 6, the insulating-film CMP apparatus 7, the CVD apparatus 8, the insulating film etching apparatuses 14 and 15, the ashing apparatus 16, the polymer removal apparatus 17, the annealing apparatus 18, the sputtering apparatus 19, the electroplating apparatus 20, and the Cu-CMP apparatus 21 are provided in the quasi flow shop section 4, and these manufacturing apparatuses are disposed approximately in order of the manufacturing steps.

In this case, two CVD apparatuses 6 and 8 are disposed in the quasi flow shop section 4. This is because the processing ability of the CVD apparatuses 6 and 8 is about half that of other manufacturing apparatuses in the quasi flow shop section 4 and is made almost equal to that of the other apparatuses.

In the quasi job shop section 5, for example, the cleaning apparatus 9, the exposure apparatus 10, the alignment inspection apparatus 11, the visual inspection apparatus 12, and the dimensional measurement apparatus 13 are provided and disposed.

In this case, if the processing ability of the manufacturing apparatuses in the quasi job shop section 5 is four times greater than that of the manufacturing apparatuses disposed in the quasi flow shop section 4, a group of the manufacturing apparatuses is disposed in the quasi flow shop section 4 so as to have four times processing ability with respect to the quasi job shop section 5.

For example, when one apparatus for each of the cleaning apparatus 9, the exposure apparatus 10, the alignment inspection apparatus 11, the visual inspection apparatus 12, and the dimensional measurement apparatus 13 is disposed in the quasi job shop section 5 and when a group of these manufacturing apparatuses has a four times greater processing ability that of the group of the manufacturing apparatuses disposed in the quasi flow shop section 4, four apparatuses for each of the CVD apparatus 6, the insulating-film CMP apparatus 7, the CVD apparatus 8, the insulating film etching apparatuses 14 and 15, the ashing apparatus 16, the polymer removal apparatus 17, the annealing apparatus 18, the sputtering apparatus 19, the electroplating apparatus 20, and the Cu-CMP apparatus 21 are disposed in the quasi flow shop section 4.

As described above, by disposing the flow shop section 2 so as to be divided into a manufacturing-apparatus group of the quasi flow shop section 4 and a manufacturing-apparatus group of the quasi job shop section 5, a difference of the processing ability can be reduced and production efficiency can be significantly improved.

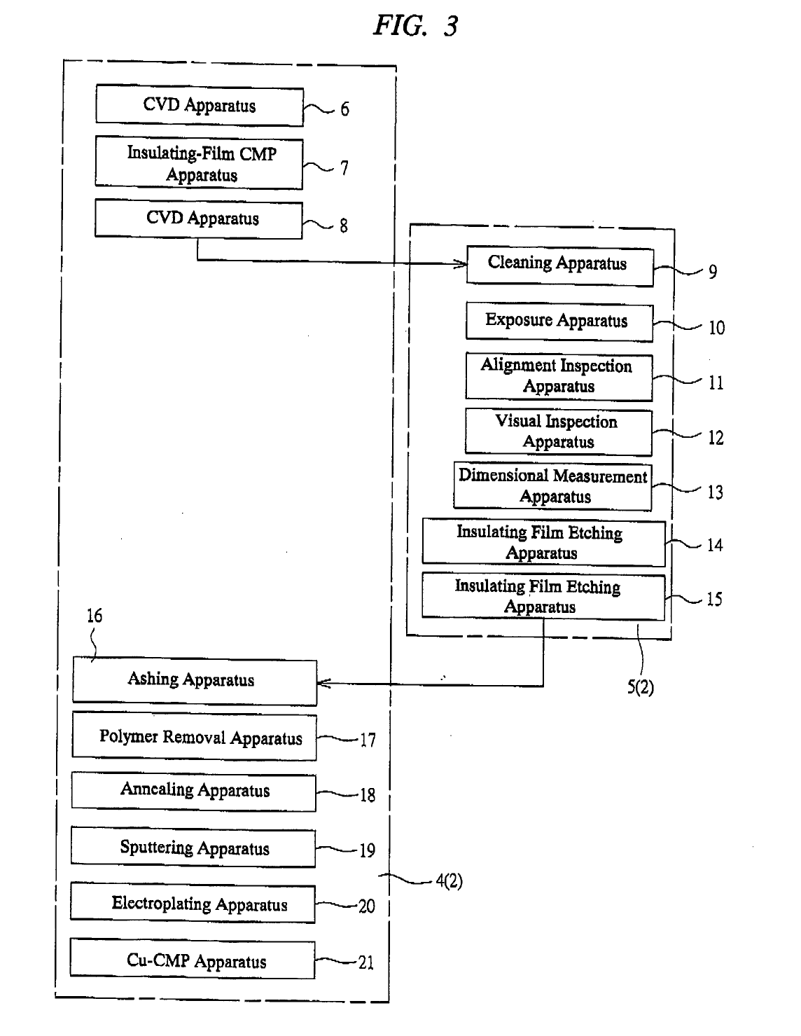

FIG. 3 is a diagram showing one example of the manufacturing apparatuses in the flow shop section 2 in the case where not only the processing ability of the manufacturing apparatuses but also factors such as respective differences in the maintenance frequency, the maintenance time, the failure frequency, and the repair time are taken into consideration as the production balance conditions.

In this case, if the factors such as respective differences of the maintenance frequency, the maintenance time, the failure frequency, and the repair time of the manufacturing apparatuses are taken into consideration as described above, the CVD apparatus 6, the insulating-film CMP apparatus 7, the CVD apparatus 8, the ashing apparatus 16, the polymer removal apparatus 17, the annealing apparatus 18, the sputtering apparatus 19, the electroplating apparatus 20, and the Cu-CMP apparatus 21 are disposed in the quasi flow shop section 4 approximately in order of the manufacture steps.

Also, in the quasi job shop section 5, the insulating film etching apparatuses 14 and 15 are newly added to the cleaning apparatus 9, the exposure apparatus 10, the alignment inspection apparatus 11, the visual inspection apparatus 12, and the dimensional measurement apparatus 13, and these apparatuses are disposed therein.

As described above, by laying out the flow shop section 2 while not only the difference of the processing ability but also the factors such as the respective difference of the maintenance frequency, the maintenance time, the failure frequency, and the repair time of the manufacturing apparatuses are taken into consideration, production efficiency is further improved significantly.

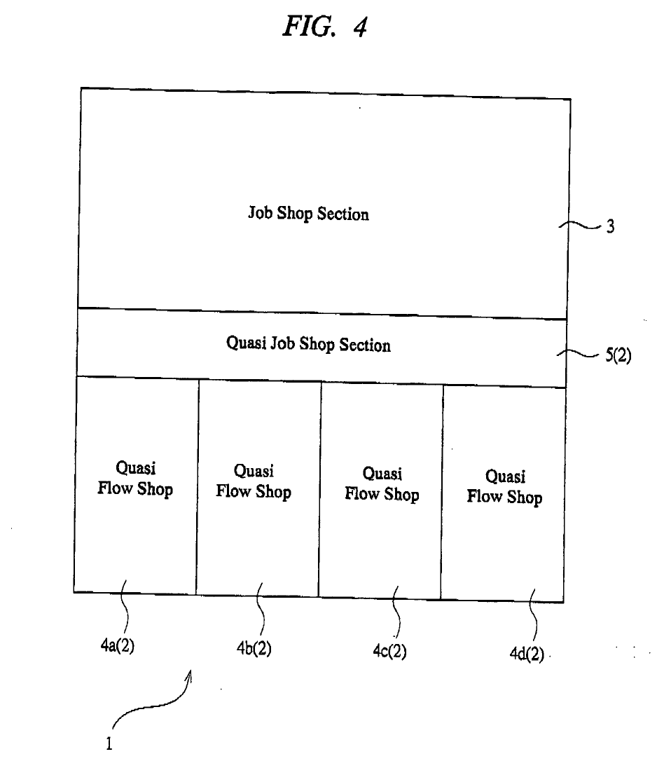

FIG. 4 is a diagram showing one example at a time of dividing the quasi flow shop section 4 into a plurality of units.

In this case, as shown in the Figure, the quasi flow shop section 4 is provided below the quasi Job shop section 5. The quasi flow shop section 4 is divided into quasi flow shops 4a to 4d, in each of which a group of apparatuses configured as a minimum unit required in the manufacturing-step flow are laid out and which are disposed from right to left in FIG. 4.

Since workers are assigned so as to exclusively belong to each of the quasi flow shops 4a to 4d, apportionment of responsibilities among the workers is clarified, whereby it Is possible to improve morale of the workers and the productivity.

Even when failure etc. occurs in any of the manufacturing apparatuses in the quasi flow shops 4a to 4d, other quasi flow shops perform backup to each other. Therefore, flexible responses even to unintentional accidents can be made.

Further, in the configuration shown in FIG. 4, the quasi job shop section 5 is provided between the job shop section 3 and the quasi flow shop section 4. However, the quasi job shop section 5 may be provided below the quasi flow shop section 4.

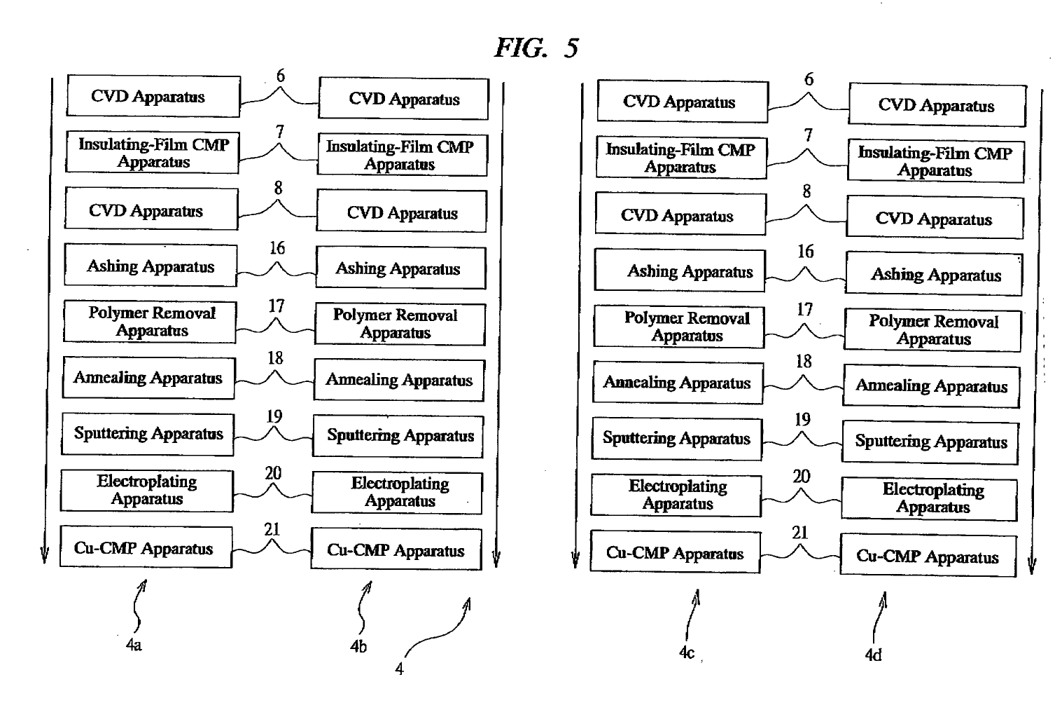

FIG. 5 is a diagram showing each arrangement example of the manufacturing apparatuses disposed in each of the quasi flow shops 4a to 4d of FIG. 4.

As shown in FIG. 5, in each of the quasi flow shops 4a to 4d, the CVD apparatus 6, the insulating film CMP apparatus 7, the CVD apparatus 8, the ashing apparatus 16, the polymer removal apparatus 17, the annealing apparatus 18, the sputtering apparatus 19, the electroplating apparatus 20, and the Cu-CMP apparatus 21 are linearly laid out approximately in order of the manufacturing steps.

Thus, by linearly disposing the manufacturing apparatuses in each of the quasi flow shops 4a to 4d approximately in order of the manufacturing steps, a distance of a manufacturing line can be shortened, Accordingly, the manufacturing line is simplified, the transfer line of the semiconductor wafers can be shortened, and the cycle time thereof can be shortened. In addition, by individually providing the quasi flow shops 4a to 4d, each group of apparatuses is limited to some extent, so that analyses etc. of defectives due to the manufacturing apparatuses can be easily made and the reliability of the semiconductor devices can be improved.

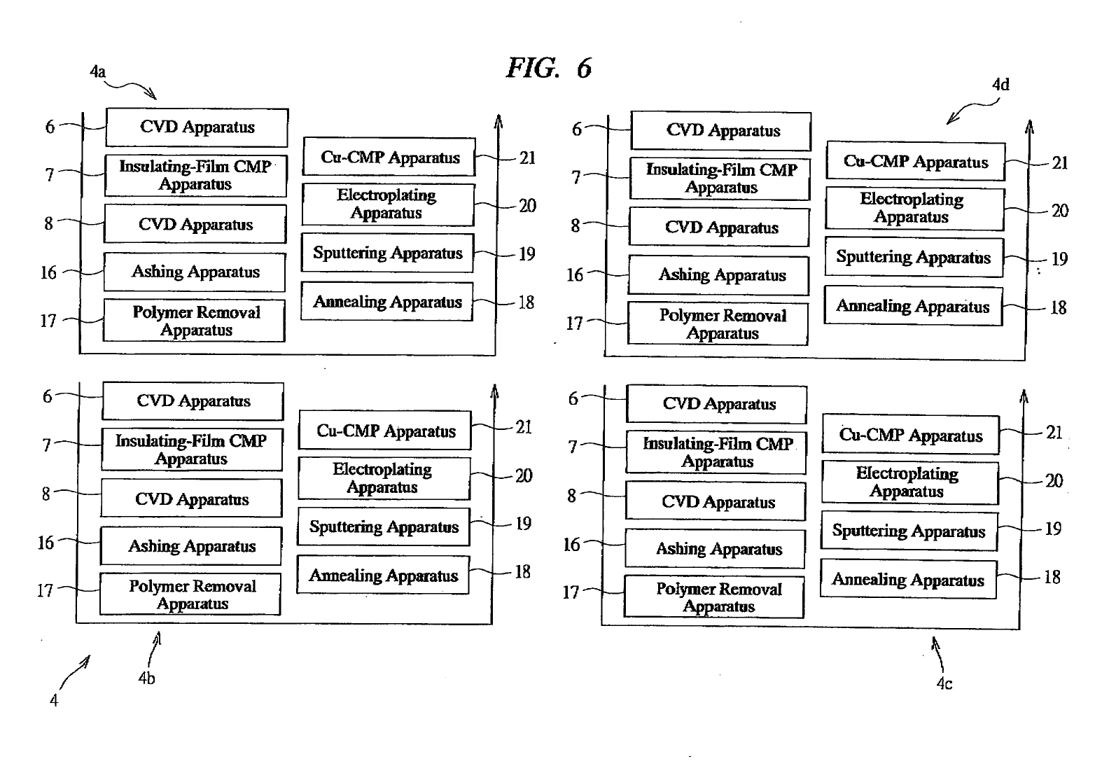

FIG. 6 is a diagram showing another arrangement example of each of the manufacturing apparatuses disposed in the quasi flow shops 4a to 4d.

Even in FIG. 6 similarly to FIG. 5, in each of the quasi flow shops 4a to 4d, the CVD apparatus 6, the insulating-film CMP apparatus 7, the CVD apparatus 8, the ashing apparatus 16, the polymer removal apparatus 17, the annealing apparatus 18, the sputtering apparatus 19, the electroplating apparatus 20, and the Cu-CMP apparatus 21 are provided.

In this case, as shown in FIG. 6, in each of the quasi flow shops 4a to 4d, the CVD apparatus 6, the insulating-film CMP apparatus 7, the CVD apparatus 8, the ashing apparatus 16, and the polymer removal apparatus 17 are linearly disposed from upper to lower on the left side. The annealing apparatus 18, the sputtering apparatus 19, the electroplating apparatus 20, and the Cu-CMP apparatus 21 are linearly disposed from lower to upper on the right side of the polymer removal apparatus 17. Therefore, the manufacturing line along the manufacturing steps has a u shape. Each of the quasi flow shops 4b to 4d also has the same configuration as that of the quasi flow shop 4a.

Also, the quasi flow shops 4a to 4d are disposed in a lattice-like manner. That is, the quasi flow shops 4a and 4d are provided from left to right below the quasi job shop section 5 (FIG. 4), and the quasi flow shop 4b is provided below the quasi flow shop 4a and the quasi flow shop 4c is provided below the quasi flow shop 4d.

As shown in FIG. 6, the transfer line is elongated by disposing the manufacturing apparatuses in the U shape. However, since the distance between the apparatuses can be shortened (particularly, a distance between the CVD apparatus 6 and the Cu-CMP apparatus 21), management etc. of the manufacturing apparatuses by workers can be easily achieved.

For example, the respective manufacturing apparatuses may be disposed so that the manufacturing line has a Z shape. In this case, the CVD apparatus 6, the insulating-film CMP apparatus 7, the CVD apparatus 8, the ashing apparatus 16, and the polymer removal apparatus 17 are linearly disposed from upper to lower. Further, respective apparatuses, from the annealing apparatus 18 which is disposed for the step next to the above-mentioned polymer removal apparatus 17, to the sputtering apparatus 19, the electroplating apparatus 20, and the Cu-CMP apparatus 21, are linearly disposed again from upper to lower.

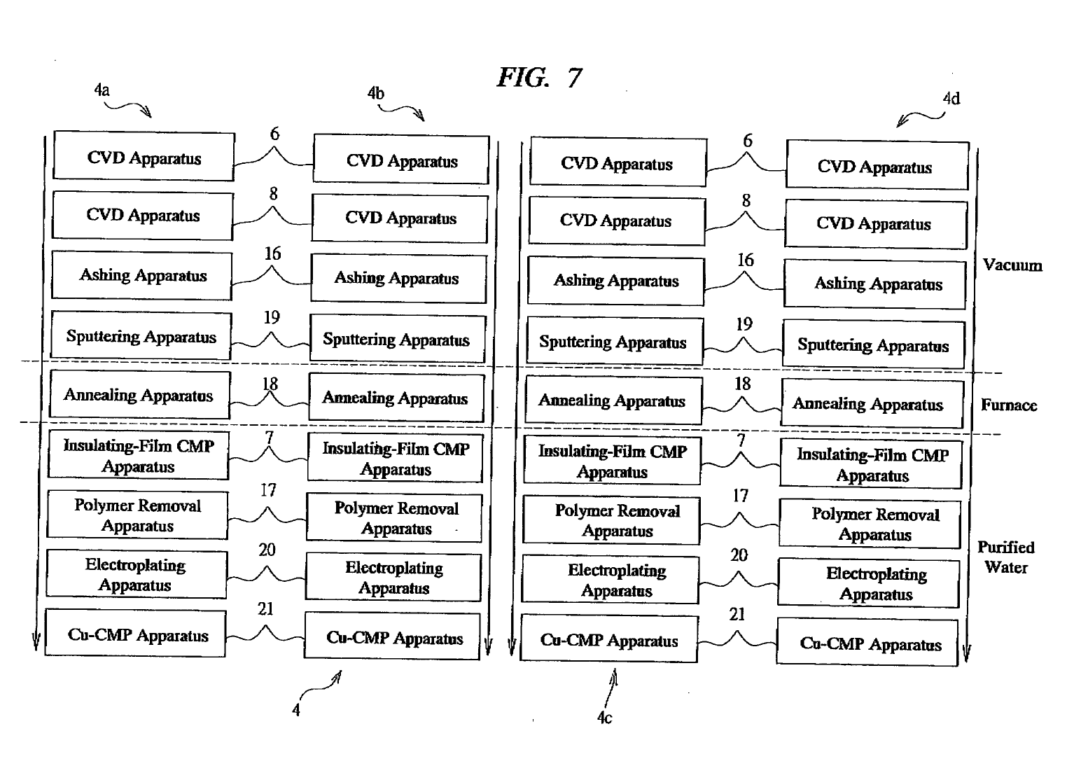

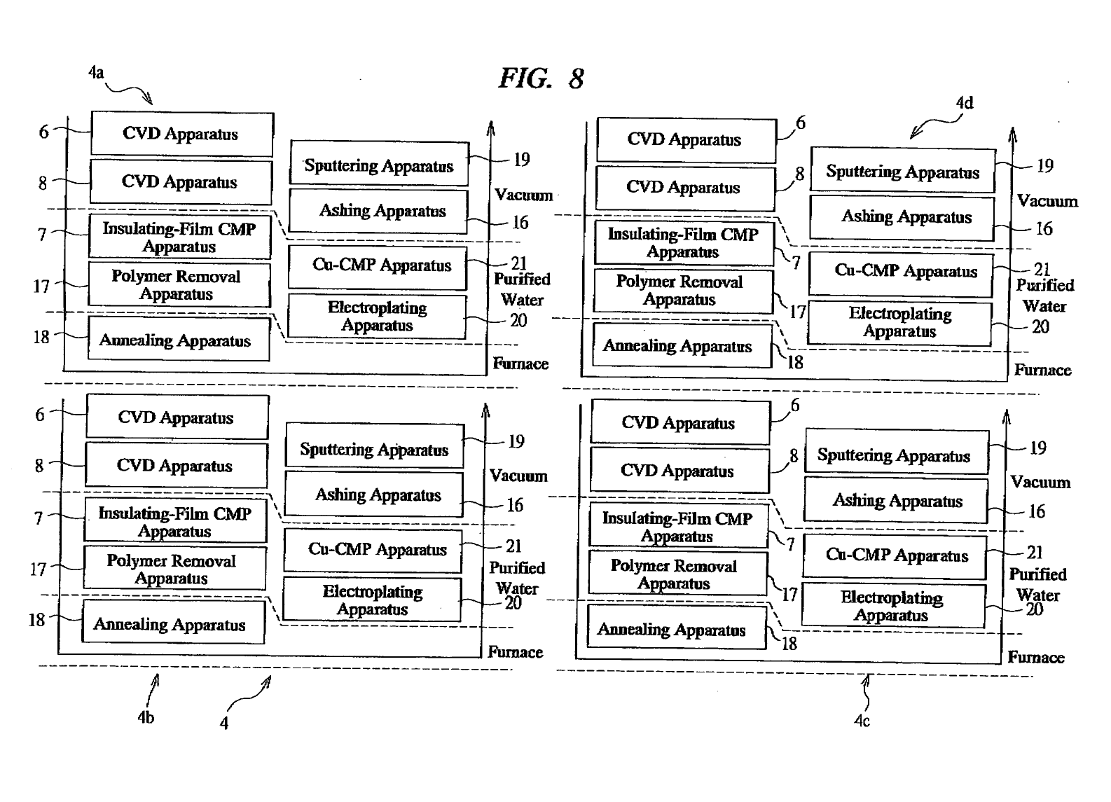

FIGS. 7 and 8 are diagrams showing other arrangement examples of each of the manufacturing apparatuses disposed in the quasi flow shops 4a to 4d in FIG. 4.

In FIG. 7 similarly to FIG. 5, the manufacturing apparatuses in each of the quasi flow shops 4a to 4d are linearly disposed. However, this case is different in that the apparatuses are not disposed approximately in order of the manufacturing steps, but are disposed on the basis of the utilities required by the manufacturing apparatuses.

In each of the quasi flow shops 4a to 4d, the CVD apparatuses 6 and 8, the ashing apparatus 16, the sputtering apparatus 19, the annealing apparatus 18, the insulating-film CMP apparatus 7, the polymer removal apparatus 17, the electroplating apparatus 20, and the Cu-CMP apparatus 21 are sequentially and linearly laid out.

The CVD apparatuses 6 and 8, the ashing apparatus 16, and the sputtering apparatus 19 are the manufacturing apparatuses, each of which requires a vacuum processing, and the annealing apparatus 18 is the apparatus that requires a high-temperature heat treatment. The insulating-film CMP apparatus 7, the polymer removal apparatus 17, the electroplating apparatus 20, and the Cu-CMP apparatus 21 are the manufacturing apparatuses, each of which requires a great amount of purified water in the manufacturing process.

Thus, by laying out the manufacturing apparatuses on the basis of the utilities required by the manufacturing apparatuses, the utilities can be supplied with good efficiency and the production cost can be reduced.

In FIG. 8 similarly to FIG. 6, the manufacturing apparatuses in each of the quasi flow shops 4a to 4d are disposed in a U shape. However, this case Is also different in that the manufacturing apparatuses are disposed on the basis of the utilities required by the manufacturing apparatuses, but not approximately in order of the manufacturing steps.

In each of the quasi flow shops 4a to 4d, the CVD apparatuses 6 and 8, the insulating-film CMP apparatus 7, the polymer removal apparatus 17, and the annealing apparatus 18 are linearly disposed from upper to lower on the left side of FIG. 8, and further the electroplating apparatus 20, the Cu-CMP apparatus 21, the ashing apparatus 16, and the sputtering apparatus 19 are sequentially and linearly laid out from lower to upper on the right side of the polymer removal apparatus 17.

In the upper side of FIG. 8, the CVD apparatuses 6 and 8, the sputtering apparatus 19, and the ashing apparatus 16, which are the manufacturing apparatuses that require vacuum processings, are disposed. Below them, the insulating film CMP apparatus 7, the polymer removal apparatus 17, the electroplating apparatus 20, and the Cu-CMP apparatus 21, which are the manufacturing apparatuses that require a great amount of purified water in the manufacturing processes, are disposed. Below them, the annealing apparatus 18, which is the apparatus that requires the high-temperature treatment, is disposed.

Also in this case, by laying out the manufacturing apparatuses on the basis of the utilities required by the apparatuses, the utilities can be supplied with good efficiency and the production cost can be reduced.

Therefore, according to the present first embodiment, the production efficiency in the semiconductor device manufacture can be improved. In addition, along with the improvement in the production efficiency, compliance of the due date of products and control of the number of products can be easily carried out.

Also, the wiring step in the semiconductor manufacture has been described in the first embodiment. However, the present invention achieves great effects when applied to various manufacturing steps which include a number of repetitive steps such as an ion implantation step where time management is important.

The semiconductor manufacturing system of the present invention is suitable as a technique, which can raise a utilization rate of the manufacturing apparatuses for semiconductor device and significantly improve the cycle time.

### Second Embodiment

In a present second embodiment, a semiconductor manufacturing system 22 is a control system for semiconductor manufacture in a flow shop line, in which manufacturing apparatuses and a transfer system are consecutively disposed in order of processing steps. For example, the manufacturing apparatuses used for such as an ion implantation step and a wiring step (a Cu (copper) damascene step and an Al (aluminum) wiring step), which include a number of frequently repeated manufacturing steps, are disposed therein.

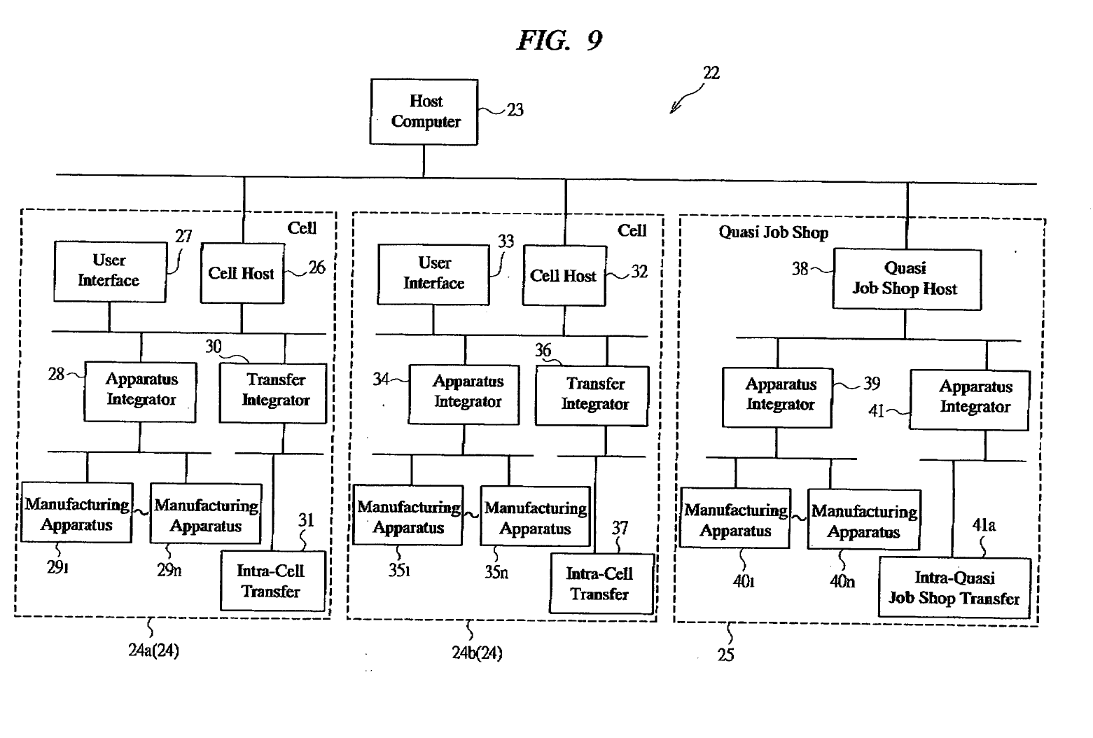

As shown in FIG. 9, a host computer 23 is provided in the semiconductor manufacturing system 22. A flow shop line is composed of a quasi flow shop 24 and a quasi job shop 25.

In the quasi flow shop 24, the manufacturing apparatuses are disposed respectively so that factors such as a processing ability difference, a maintenance frequency difference, a maintenance time difference, a failure frequency difference, and a repair time difference among the respective manufacturing apparatuses are taken into consideration and that a balance in productivity is achieved. The quasi flow shop 24 is divided into cells 24a and 24b, in each of which a group of apparatuses having the minimum unit required in the manufacturing step flow is laid out, and these cells are disposed therein.

The cell 24a is composed of a cell host (intra-cell manufacture management means or cell host computer) 26, a user interface (intra-cell manufacture management means or interface terminal) 27, an apparatus integrator (intra-cell manufacture management means or intra-cell apparatus integrator) 28, manufacturing apparatuses 29₁, to 29ₙ, an transfer integrator (intra-cell manufacture management means or intra-cell transfer integrator) 30, and an intra-cell transfer 31.

The cell 24b is composed of a cell host (intra-cell manufacture management means or cell host computer) 32, a user interface (intra-cell manufacture management means or interface terminal) 33, an apparatus integrator (intra-cell manufacture management means or intra-cell apparatus integrator) 34, manufacturing apparatuses 35₁ to 35ₙ, an transfer integrator (intra-cell manufacture management means or intra-cell transfer integrator) 36, and an intra-cell transfer 37.

Also, in the cell 24a(, 24b), for example, a CVD apparatus, an insulating-film CMP apparatus, an ashing apparatus, a polymer removal apparatus, an annealing apparatus, a sputtering apparatus, an electroplating apparatus, and a Cu-CMP apparatus are provided as the manufacturing apparatuses 29₁ to 29ₙ(35₁ to 35ₙ), respectively, and these apparatuses are disposed approximately in order of the manufacturing steps. The cells 24a and 24b are disposed, for example, in parallel to each other. Accordingly, the distance of the manufacturing line can be shortened, the manufacturing line can be simplified, the transfer line of the semiconductor wafers can be shortened, and the cycle time can be shortened.

The quasi job shop 25 is composed of a quasi job shop host 38, an apparatus integrator 39, manufacturing apparatuses 40₁ to 40ₙ, a transfer integrator 41, and an intra-quasi job shop transfer 41a.

In the quasi job shop 25, the manufacturing apparatuses, in each of which a balance in productivity is not achieved due to a low or high processing ability of each manufacturing apparatus, are respectively disposed and provided so as to be shared by each of the cells 24a and 24b of the quasi flow shop 24.

In the quasi job shop 25, for example, a cleaning apparatus, an exposure apparatus, an alignment inspection apparatus, a visual inspection apparatus, a dimensional measurement apparatus, and an insulating-film etching apparatus are provided as the manufacturing apparatuses 40₁ to 40ₙ.

The CVD apparatus supplies a compound gas or a single-component gas made of an element(s) composed of a thin film material to the semiconductor wafers, and forms desired thin films through a chemical reaction caused in a gas phase or on the surface of the semiconductor wafer. The insulating-film CMP apparatus planarizes interlayer dielectric films.

The cleaning apparatus performs cleaning of the semiconductor wafers. The exposure apparatus exposes mask patterns to the semiconductor wafers. The alignment inspection apparatus inspects alignment of the exposed patterns. The visual inspection apparatus inspects defects of the mask patterns etc.

The dimensional measurement apparatus measures the dimension of, for example, the patterns formed on the surfaces of the semiconductor wafers. The insulating-film etching apparatus etches insulating films formed on the surfaces of the semiconductor wafers. The ashing apparatus performs an ashing process to resist on the semiconductor wafers. The polymer removal apparatus removes unnecessary polymer films from the semiconductor wafers.

The annealing apparatus performs a heat treatment to the thin films on the semiconductor wafers. The sputtering apparatus forms the thin films to be barrier conductive films in wiring layers by a sputtering phenomenon. The electroplating apparatus performs electroplating of Cu to be wirings. The Cu-CMP apparatus planarizes the wiring layers.

Herein, the above-described manufacturing apparatuses are one example, and the manufacturing apparatuses employed in the quasi flow shop 24 and the quasi job shop 25 are not limited thereto.

By repeating the manufacturing steps in the quasi flow shop 24 and the quasi job shop 25, wirings are formed on the semiconductor wafers.

The cell hosts (cell host computers) 26 and 32 and the quasi job shop host 38 are mutually connected to the host computer 23. In the cell 24a, each of the user interface 27, the apparatus integrator 28, and the transfer integrator 30 is connected to the cell host 26. Each of the manufacturing apparatuses 29₁ to 29ₙ is connected to the apparatus integrator 28. The intra-cell transfer 31 is connected to the transfer integrator 30.

In the cell 24b, each of the user interface 33, the apparatus integrator 34, and the transfer integrator 36 is connected to the cell host 32. Each of the manufacturing apparatuses 35₁ to 35ₙ is connected to the apparatus integrator 34. The intra-cell transfer 37 is connected to the transfer integrator 36.

In the quasi job shop 25, each of the apparatus integrator 39 and the transfer integrator 41 is connected to the quasi job shop host 38. Each of the manufacturing apparatuses 40₁ to 40ₙ is connected to the apparatus integrator 39. The intra-quasi job shop transfer 41a is connected to the transfer integrator 41.

The host computer 23 manages all the control in the semiconductor manufacturing system 22, and controls each of the cells 24a and 24b as an independent manufacturing line. According to instructions given from the host computer 23, the cell hosts 26 and 32 control the apparatus integrators 28 and 34 and the transfer integrators 30 and 36, respectively.

The user interface 27 is composed of a personal computer etc., and is an interface with the cell host 26. The user interface 33 is also an interface with the cell host 32.

According to the control executed by the cell host 26, the apparatus integrator 28 performs all the management of the manufacturing apparatuses 29₁ to 29ₙ such as an instruction of work initiation, and an instruction of recipe that is the processing conditions in the manufacturing apparatuses. The transfer integrator 30 performs management of the intra-cell transfer 31. The intra-cell transfer 31 performs local area transfer within the cell 24a according to the transfer information outputted from the transfer integrator 30.

According to the control executed by the cell host 32, the apparatus integrator 34 performs all the management of the manufacturing apparatuses 35₁ to 35ₙ such as an instruction of work initiation, and an instruction of the recipe. The transfer integrator 36 performs management of the intra-cell transfer 37. The intra-cell transfer 37 performs local area transfer within the cell 24b according to the transfer information outputted from the transfer integrator 36.

According to instructions given from the host computer 23, the quasi job shop host 38 controls the apparatus integrator 39 and the transfer integrator 41. According to the control executed by the quasi Job shop host 38, the apparatus integrator 39 performs all the management of the manufacturing apparatuses 40₁ to 40ₙ such as an instruction of work initiation and an instruction of the recipe. The transfer integrator 41 performs management of the intra-quasi job shop transfer 41a. The intra-quasi job shop transfer 41a performs local area transfer within the quasi job shop 25 according to the transfer information outputted from the transfer integrator 41.

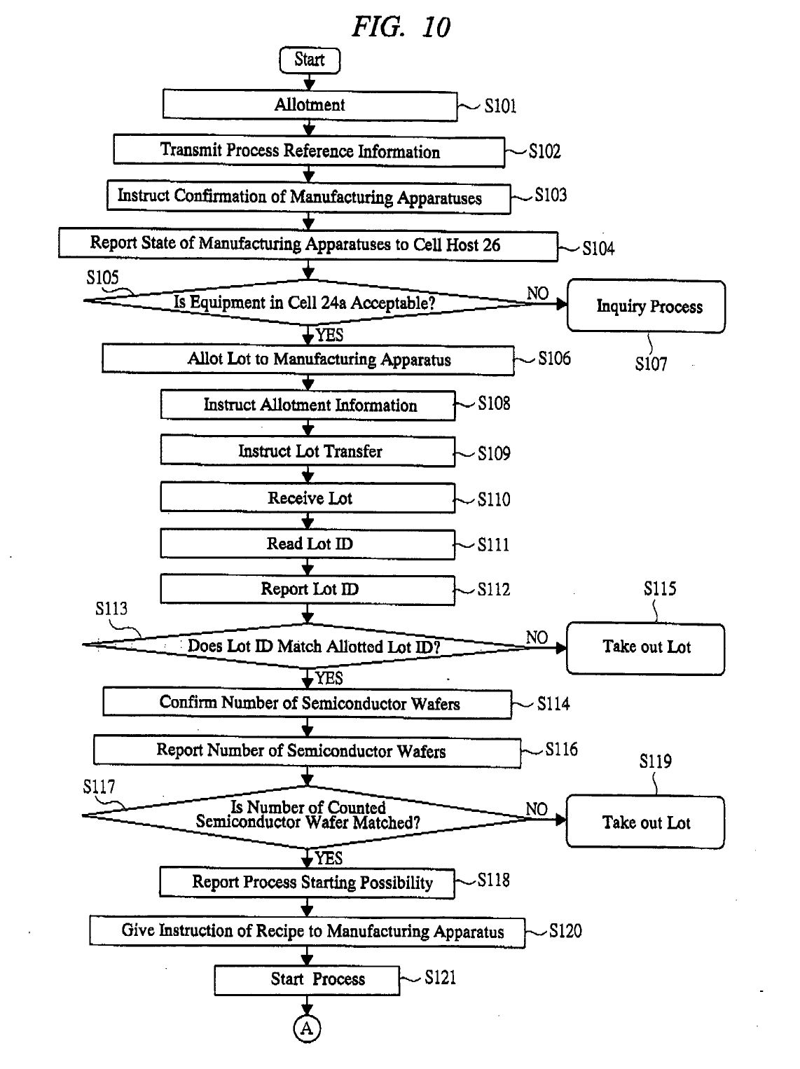

Next, an operation of the quasi flow shop 24 which is provided in the semiconductor manufacturing system 22 according to the present embodiment will be explained by use of the flow charts of FIG. 10 to FIG. 13.

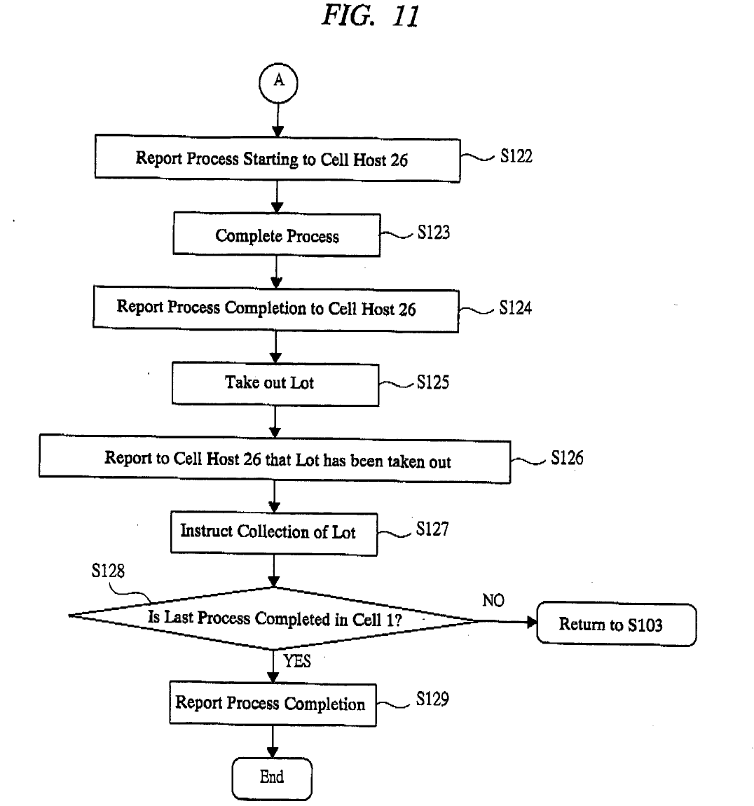

First, in the flow charts of FIG. 10 and FIG. 11, the host computer 23, on the basis of various pieces of information such as availability information of the manufacturing apparatuses in the cells 24a and 24b, and the number of lots being currently processed in each of the cells 24a and 24b, determines in which one of the cells 24a and 24b the process is performed (hereinafter referred to as “allotment”) (step S101). Herein, the “availability information” includes information of whether the manufacturing apparatuses can be used for production, and whether the apparatuses are in course of processes or on standby.

For example, when the allotment is performed to the cell 24a in a process of step 5101, the host computer 23 transmits process reference information in the cell 24a to the cell host 26 (step S102). Herein, the “process reference information” is information for processing materials in a lot and being completed as products and, particularly, it consists of information about, for example, the manufacturing apparatuses used in each step, and the conditions (recipe) for being processed in the manufacturing apparatuses.

Subsequently, with respect to the apparatus integrator 28, the cell host 26 makes a confirmation of, for example, whether each of the manufacturing apparatuses is in a state used for production (whether failure etc. is present or not), whether the lot being currently processed can be mounted on each apparatus, or whether each apparatus is in an unused state and in a state of waiting for the lot (step S103).

In response to a status confirmation request from the cell host 26, the apparatus integrator 28 makes a report to the cell host 26 (step S104). According to the report made by the apparatus integrator 28, the cell host 26 determines whether equipment in the cell 24a is acceptable (step S105).

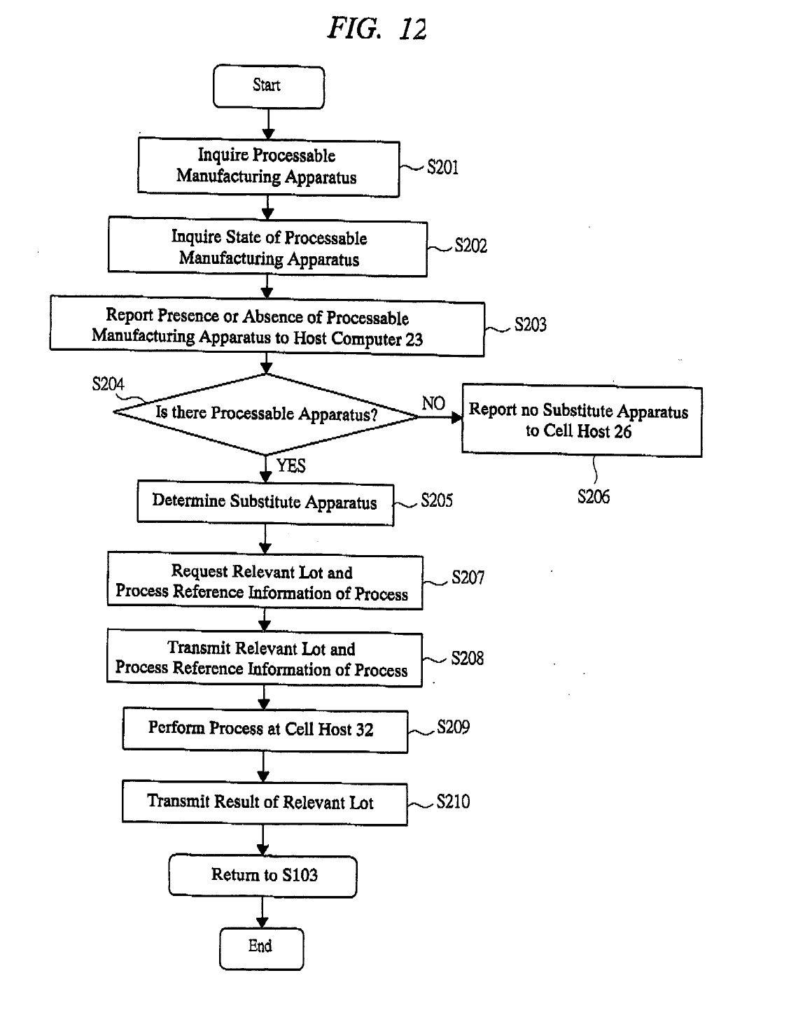

In the process of the step S105, when it is acceptable, the cell host 26 allots (or assigns) a lot to the manufacturing apparatus in the cell 24a (step S106). When the equipment is not acceptable, an inquiry process shown in FIG. 12 is performed (step S107).

Thereafter, the cell host 26 gives instructions of allotment information to the apparatus integrator 28 and the transfer integrator 30 (step S108). The “allotment information” is information representing the recipe in the apparatus integrator 28, and is information indicating by which manufacturing apparatus a process is performed in the transfer integrator 30.

When the transfer integrator 30 receives the allotment information, the transfer integrator 30 instructs the intra-cell transfer 31 to convey the lot (step S109). Then, a certain manufacturing apparatus receives the lot from the intra-cell transfer 31 (step S110), the manufacturing apparatus reads an ID number of the received lot (step S111) and reports the read ID number to the apparatus integrator 28 (step S112).

The apparatus integrator 28 determines whether the ID number of the transferred lot and the ID number of the lot instructed to be transferred are the same (step S113). When they match, the manufacturing apparatus confirms the number of semiconductor wafers (step S114). When the ID numbers of the lot do not match in the process of the step S113, the lot is brought out of the manufacturing apparatus (step S115) and the processes from the step S101 are repeated again to the above-mentioned lot.

Subsequently, the manufacturing apparatus reports the counted number of the semiconductor wafers to the apparatus integrator 28 (step S116). When the counted number of the semiconductor wafers matches the instructed number (step S117), the manufacturing apparatus reports to the apparatus integrator 28 that processes can be started (step S118). When the number of the counted semiconductor wafers do not match the instructed number in the process of the step S117, the lot is brought out of the manufacturing apparatus (step S119), and the processes from the step S101 are repeated again to the above-mentioned lot.

Thereafter, the cell host 26 gives an instruction of recipe to the manufacturing apparatus via the apparatus integrator 28 (step S120), and a process to be performed by the above manufacturing apparatus is started (step S121).

When the process is started, the manufacturing apparatus makes a report of a process starting time via the apparatus integrator 28 (step S122). Then, when the process by the manufacturing apparatus is completed (step S123), the above manufacturing apparatus reports the process completion information, which is configured from a process completion time and the number of processed wafers, to the cell host 26 via the apparatus integrator 28 (step S124), and then takes out the lot (step S125).

At this time, the cell host 26 executes a production management process based on the information reported in the processes of steps S122 and S124, and displays the process result at the user interface 27. Specifically, the cell host calculates a production volume in the cell 24a by accumulating the number of processed wafers which is included in the process completion information, and calculates a cycle time from the process starting time and the process completion time, Then, the results are displayed at the user interface 27 in real time and subjected to statistical processing, whereby productivity thereof can be significantly improved.

After the lot is taken out, the manufacturing apparatus reports, to the cell host 26 via the apparatus integrator 28, that the lot has been taken out (step S126). In response to reception of the report, the cell host 26 instructs the apparatus integrator 28 to collect the lot (step S127).

Thereafter, the cell host 26 determines whether all the processes in the cell 24a have been completed (step S128). In the process of the step S128, when the processes have not been completed, the processes from the step S103 are executed again. When the processes have been completed, the cell host 26 reports to the host computer 23 that the processes in the cell 24a have been completed (step S129).

Thus, by independently controlling the cells 24a and 24b which are the minimum units in the quasi flow shop 24, management of important production indexes such as a production volume, a cycle time, and a yield rate in the minimum unit can be easily made, and compliance of the due date, and control of production quantity, or the like can be easily achieved.

In addition, even when failure occurs in any one of the manufacturing apparatuses in the cells 24a and 24b, the other cell performs mutual backup, whereby flexible responses even to unintentional accidents can be made.

Next, the inquiry process which is the process of the step S107 (FIG. 10) will be explained in detail by use of a flow chart of FIG. 12.

First, the cell host 26 inquires the host computer 23 about the manufacturing apparatuses that can perform processes (step S201). In response to the inquiry, the host computer 23 inquires the cell host 32 of the cell 24b and the quasi job shop host 38 of the quasi job shop 25 about states of their manufacturing apparatuses (step S202).

Subsequently, the cell host 32 and the quasi job shop host 38 reports to the host computer 23 the presence or absence of the manufacturing apparatuses that can perform processes (step S203).

Based on the reports made by the cell host 32 and the quasi job shop host 38, the host computer 23 judges whether there are the manufacturing apparatuses that can perform the process (step S204). When there are manufacturing apparatuses that can perform a process, the host computer 23 determines a manufacturing apparatus that can serve as a substitute (step S205). Meanwhile, when no manufacturing apparatus that can perform a process is provided in the process of the step S204, the host computer gives the cell host 26 an answer indicating that no apparatus can serve as a substitute (step S206). After a predetermined period of time, the processes from the step S103 are performed.

Then, the host computer 23 requests the relevant lot and the process reference information of process to the cell host 26 (step S207). The host computer 23 transmits the relevant lot and the process reference information to the cell host 32 which has the substitute apparatus (step S208). Then, the cell host 32 performs the same processes as those of the steps S105 to S127 shown in FIGS. 10 and 11 (step S209).

Then, whether all the processes in the cell 24b have been completed or not is checked. When the processes have not been completed, the processes from the step S103 are executed again. When the processes are completed, the host computer 23 transmits the results of the relevant lot to the cell host 26 (step S210), and the processes from the step S103 are repeated again.

The results of the lot transmitted from the host computer 23 comprises, for example, a process starting time, the number of processed wafers, a process completion time, a process condition, and information about the manufacturing apparatus having been actually processed.

By the inquiry process, when a manufacturing apparatus of one cell of the cells 24a and 24b is to be stopped due to, for example, failure or maintenance over a long period, backup can be easily and flexibly performed by the same type of manufacturing apparatus in the other cell, so that reduction in the production efficiency can be suppressed to the minimum level.

Also, each of the user interfaces 27 and 33 is provided with a recognition means for recognizing predetermined workers by use of recognition information such as passwords or biometric information of fingerprints.

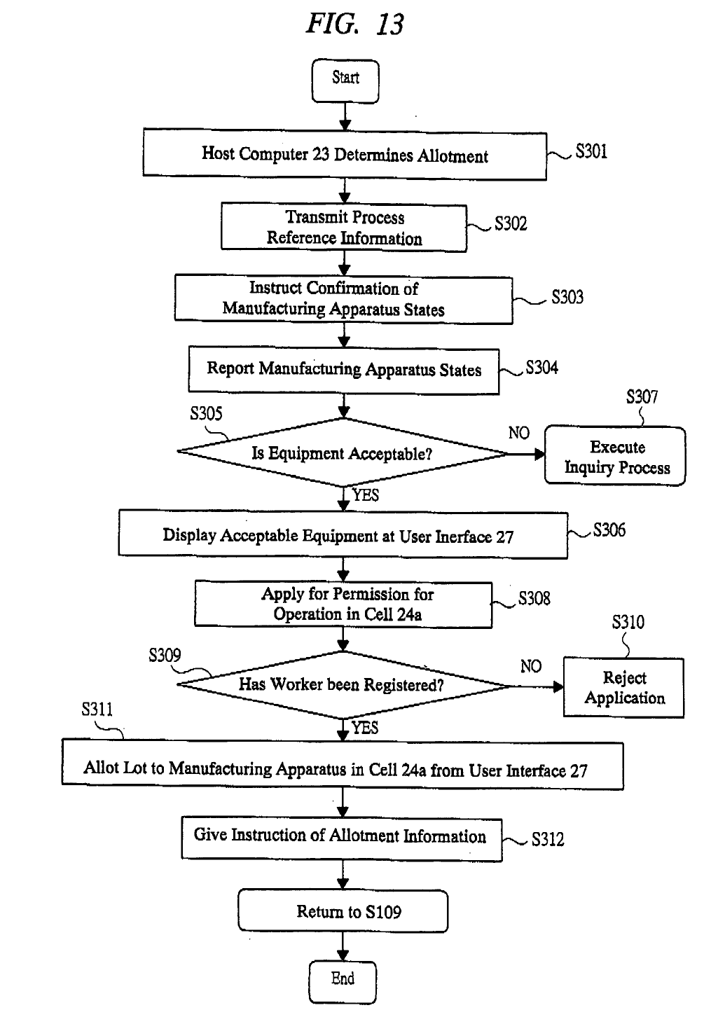

FIG. 13 is a flow chart at a time of limiting a worker who can operate the cells 24a and 24b by the recognition means of the user interfaces 27 and 33.

First, the host computer 23 determines an allotment, based on various pieces of information such as availability information of the manufacturing apparatuses in the cells 24a and 24b, and the number of lots being currently processes in each of the cells 24a and 24b (step S301).

When the allotment is made to the cell 24a in the process of step S301, the host computer 23 transmits the process reference information of the processes within the cell 24a to the cell host 26 (step S302).

Subsequently, with respect to the apparatus integrator 28, the cell host 26 makes a confirmation of whether each of the manufacturing apparatuses is in states of being used for production (whether failure or the like is present or not), whether the lot being currently processed cannot be mounted on each of the apparatuses, or whether each apparatus is in an unused state and in a state of waiting for the lot (step S303).

In response to a status confirmation request made by the cell host 26, the apparatus integrator 28 makes a report to the cell host 26 (step S304). According to the report made by the apparatus integrator 28, the cell host 26 judges whether the equipment in the cell 24a is acceptable (step S305).

In the process of the step S305, when the equipment is acceptable, the cell host 26 transmits the information to the user interface 27 and displays the acceptable manufacturing apparatuses to the user interface 27 (step S306). Meanwhile, when the equipment is not acceptable, the inquiry process shown in FIG. 12 is performed (step S307).

Subsequently, a worker inputs a password such as a personal identification number from the user interface 27, and applies to the cell host 26 in order to obtain permission to perform operations within the cell 24a (step S308). Based on the inputted password, the cell host 26 judges whether the worker has been already registered or not (step S309). When the worker has not been registered, the application is rejected (step S310) and the rejection is displayed on the user interface 27 and an interlock is activated so that the worker cannot perform further operation.

When the worker has been registered in the process of the step S309, the cell host 26 gives permission to use the user interface 27 and the worker allots the lots to the manufacturing apparatus in the cell 24a via the user interface 27 (step S311).

Then, the cell host 26 gives instructions to the apparatus integrator 28 and the transfer integrator 30 on the basis of the allotment information (step S312). Subsequently, processes following the step S109 of FIG. 10 are executed.

Thus, by limiting the workers in each of the cells 24a and 24b, a relation among the workers and the production volume and quality etc. can be enhanced, so that apportionment of responsibilities can be further clarified so as to improve morale of the workers and concurrently the productivity of the semiconductor devices can be improved.

Therefore, according to the present embodiment, the productivity in the manufacture of the semiconductor devices can be significantly improved.

In the present second embodiment, the wiring step in the semiconductor manufacture has been described. However, the present invention achieves great effects when applied to various manufacturing steps which include a number of repetitive steps such as an ion implantation step where time management is important.

In the second embodiment, there described the case where two cells which are the minimum units of the quasi flow shop are provided. However, the number of the cells is not limited thereto and may be one, or three or more.

The semiconductor manufacturing system of the present invention is suitable as a technique, which can raise a utilization rate of the manufacturing apparatuses for semiconductor device and significantly improve the cycle time.

### Third Embodiment

A transfer system (or conveyance system) of a present third embodiment has such a configuration that a transfer time in a direction extending along the process flow in a cell area employing a flow shop system layout becomes the shortest one.

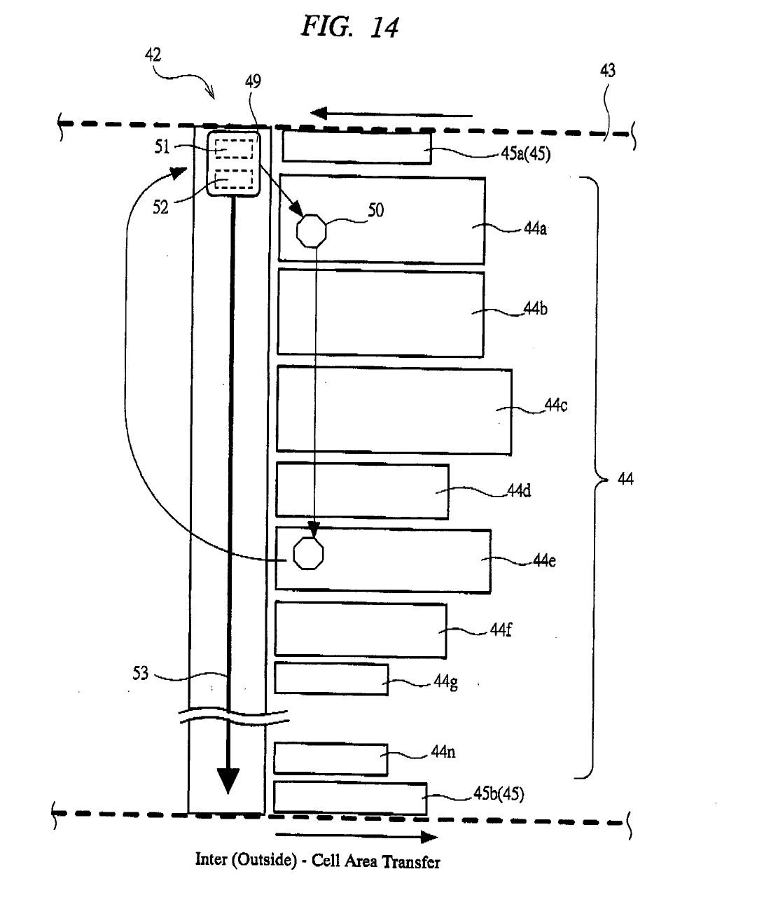

As shown in FIG. 14, a transfer system of the present embodiment 1s configured to have a flow shop area 42 in which a plurality of manufacturing apparatuses are arranged along the flow of processes, and a guided vehicle 49 for conveying products between the plurality of manufacturing apparatuses in the flow shop area 42.

The flow shop area 42 is divided into a plurality of cell areas 43, each of which is composed of a group of manufacturing apparatuses as a minimum unit required in the step, and, in each of the cell areas 43, a plurality of manufacturing apparatuses 44 are arranged along the flow of process in a direction extending from upstream to downstream.

The guided vehicle 49 has driving wheels 51 set on a rear-wheel side and a decelerator(s) 52 set on a front-wheel side with respect to a transfer direction of a product 50. The guided vehicle 49 is set to a standby condition at an upstream position on a transfer path 53 in the transfer direction of the product 50.

Such a transfer system is employed in, for example, a semiconductor manufacturing system in a semiconductor manufacturing line, although the transfer system is not limited thereto.

The semiconductor manufacturing system is composed to have: a transfer system having the above-described flow shop area 42 and the guided vehicle 49; and a plurality of manufacturing apparatuses 44 arranged along the flow of process in the flow shop area 42 and executing processes or inspection to the semiconductor wafers of the product 50 conveyed and delivered by the guided vehicle 49.

In such a semiconductor manufacturing line, although no particular limitation is imposed thereon, the manufacturing apparatuses 44 are divided into some groups of manufacturing apparatuses as the minimum units which are called cells and required in the step, and the divided apparatuses are disposed in units of cell in each of the cell areas 43 of the flow shop area 42 in the clean room. For this reason, also in the transfer system of the semiconductor wafers, the transfer can be classified accordingly into intra-cell area transfer, inter-cell area transfer, and transfer across the above-described areas.

In these types of transfer, for example, a guided vehicle called a RGV (Rail Guided Vehicle) which automatically drives on a rail, a guided vehicle called a AGV (Automatic Guided Vehicle) which automatically drives without a rail, a guided vehicle called an OHT (Over-head Hoist Transport), or a guided vehicle called an OHS (Overhead Shuttle) is employed. Mostly, a guided vehicle such as an RGV or AGV Is employed in the intra-cell area transfer, and a guided vehicle such as an OHT or OHS is employed in the inter-cell area transfer or for the transfer across the above-described areas.

The manufacturing apparatuses 44 (44a to 44n) include, for example, various processing apparatuses for performing various processes to the semiconductor wafers, such as a heat treatment apparatus, an ion implantation apparatus, an etching apparatus, a film formation apparatus, a cleaning apparatus, a photo resist coating apparatus, and an exposure apparatus, and also include various inspection apparatuses for executing an inspection after each of the above-mentioned processes, such as a film-thickness inspection apparatus. Further, by dividing each of these processing apparatuses and inspection apparatuses into some cell units, the wafers are transferred between the apparatuses with good efficiency, and by taking into account a process wait etc. for the process performed by the next apparatus, stations or stockers (hereinafter collectively referred to as “stations”) 45a and 45b etc. for keeping the semiconductor wafers are disposed at upstream and downstream portions thereof.

For example, the above-mentioned case shown in FIG. 14 is provided on the assumption that the present invention is applied to a wiring step performed in the cell area 43 after forming the transistors on the semiconductor wafers. Operations such as start/end of the processes performed by each of the processing apparatuses composed of the manufacturing apparatuses 44 disposed in the cell area 43 for a wiring formation step, start/end of the inspection made by each of the inspection apparatuses composed of the manufacturing apparatuses 44, and start/end of the transfer carried out by the guided vehicle 49, etc. are controlled by an un-illustrated control system which is electrically connected to the manufacturing apparatuses 44 and the guided vehicle 49.

Note that in the semiconductor manufacturing system, generally, in addition to the flow shop area 42, the job shop area in which a plurality of manufacturing apparatuses are disposed based on the functions of the processes (e.g., a transistor formation step) is provided and a combination of the job shop area and the flow shop area, etc. is disposed in the space of the plant.

Next, one example of an intra-cell area transfer operation in a transfer system (semiconductor manufacturing system) according to the present embodiment will be described. Herein, the intra-cell area transfer is explained as an example. However, in the transfer between the cell areas, the transfer performed across an inside of the cell area and over the cell area, and the transfer performed in a combined area of the job shop area and the flow shop area, only the transfer areas are different and the transfer operations thereof are the same.

For example, when the guided vehicle 49 receives a transfer instruction, it receives, from the upstream station 45a on the transfer path 53, a cassette storing the semiconductor wafers (a lot unit or a plurality of lots) of the product 50 kept in the station 45a (hereinafter referred to as “wafer cassette”), carries the wafer cassette to a first processing apparatus (44a) for performing a predetermined process to the semiconductor wafers, and loads the wafer cassette to a first port of the first processing apparatus (44a). The guided vehicle 49 which has finished delivering the wafer cassette returns to the upstream portion and is place in a standby condition. Then, the first processing apparatus (44a) performs a predetermined process to the semiconductor wafers.

Then, when the guided vehicle 49 receives a next transfer instruction after the process of the first processing apparatus (44a) has been completed, it moves to the first processing apparatus (44a), receives the wafer cassette from the first port of the first processing apparatus (44a), carries the wafer cassette to a second processing apparatus (44b) for performing a predetermined process to the semiconductor wafers, and loads the wafer cassette to a first port of the second processing apparatus (44b). The guided vehicle 49 which has finished delivering the wafer cassette returns to the upstream portion again and is placed in a standby condition. Then, the second processing apparatus (44b) performs the predetermined process to the semiconductor wafers.

Subsequent steps are the same as the above-mentioned steps. That is, also in the various types of processing apparatuses such as a third processing apparatus (44c), a fourth processing apparatus (44d), . . . , the predetermined processes are sequentially performed to the semiconductor wafers from one processing apparatus to the next processing apparatus, or via the later-described inspection apparatuses. The wafer cassette in which the processes have been eventually completed is delivered to the downstream station 45b on the transfer path 53 in order to keep the processed wafer cassettes.

Also at various inspection apparatuses (44g) for semiconductor wafers in which the predetermined processes have been completed or the final processes have been completed, the wafer cassette is delivered between the vehicle 49 and each of the various inspection apparatuses (44g) in the same manner as the transfer to the various processing apparatuses as described above, and various types of inspections are executed.

In another process having a process flow which is similar to that of the example of the above-described flow shop and to which the above-described flow shop can be applied, even when partial processes of the processing apparatuses (44) are not required, the same flow shop can be shared only by skipping the above processing apparatuses (44), and the transfer operation in this case is also performed in the same manner as described above.

Therefore, according to the transfer system of the present embodiment and the semiconductor manufacturing system employing the transfer system, since the guided vehicle 49 has the driving wheels 51 set on the rear-wheel side and the decelerator(s) 52 set on the front-wheel side with respect to a transfer direction of the product 50, stable drive performance (acceleration, drive, and deceleration) can be obtained at a time of running in the transfer direction. In addition, since the guided vehicle 49 is placed in the standby condition at the upstream portion on the transfer path 53 with respect to the transfer direction of the product 50, the wait time of the guided vehicle 49 can be shortened. Consequently, this leads to shortening of the cycle time for manufacturing the semiconductor products.

### Fourth Embodiment

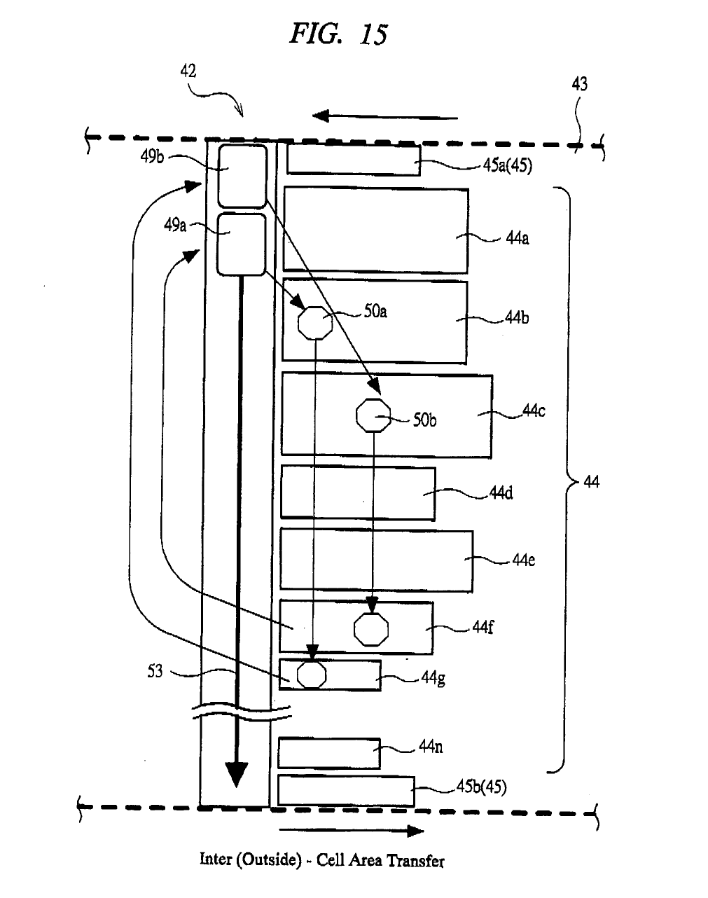

A transfer system (or conveyance system) of a present fourth embodiment has the same object as that of the third embodiment, and has such a configuration that a transfer time in a direction extending along a process flow in the cell area employing the flow shop system layout becomes the shortest time. As shown in FIG. 15, in a configuration having the flow shop area (cell area 43) and the guided vehicles 49, the number of guided vehicles 49 is two or more (in the Figure, two) and the guided vehicles 49 (49a and 49b) are moved on one rail, wherein they are placed in the standby condition at the upstream portion on the transfer path 53 in the transfer direction of the products (50a and 50b).

Therefore, in the transfer operation of the transfer system according to the present embodiment, for example, until a transfer instruction is given, the two guided vehicles 49a and 49b are placed in the standby conditions at the upstream portion on the transfer path 53 constituted by one rail. When the transfer instruction is given, the front guide vehicle 49a moves to the corresponding manufacturing apparatus 44b which Is a processing apparatus or inspection apparatus to receive the product 50a, conveys the product to the manufacturing apparatus 44g, returns to the upstream portion after completion of the transfer, and is placed in the standby condition. If a next transfer instruction is given during the transfer of the front guided vehicle 49a, the rear vehicle 49b moves to the corresponding manufacturing apparatus 44c, and performs delivery of the product 50b.

Therefore, according to the present embodiment, the number of guided vehicles 49 is two or more and the guided vehicles 49a and 49b are moved on the one rail and are placed in the standby conditions at the upstream portion on the transfer path 53 in each transfer direction of the products 50a and 50b. Therefore, the transfer time can be shortened without causing drive interference between the guided vehicles 49a and 49b, and each wait time of the guided vehicles 49a and 49b is shortened, whereby this leads to shortening of each cycle time for manufacturing the semiconductor products.

### Fifth Embodiment

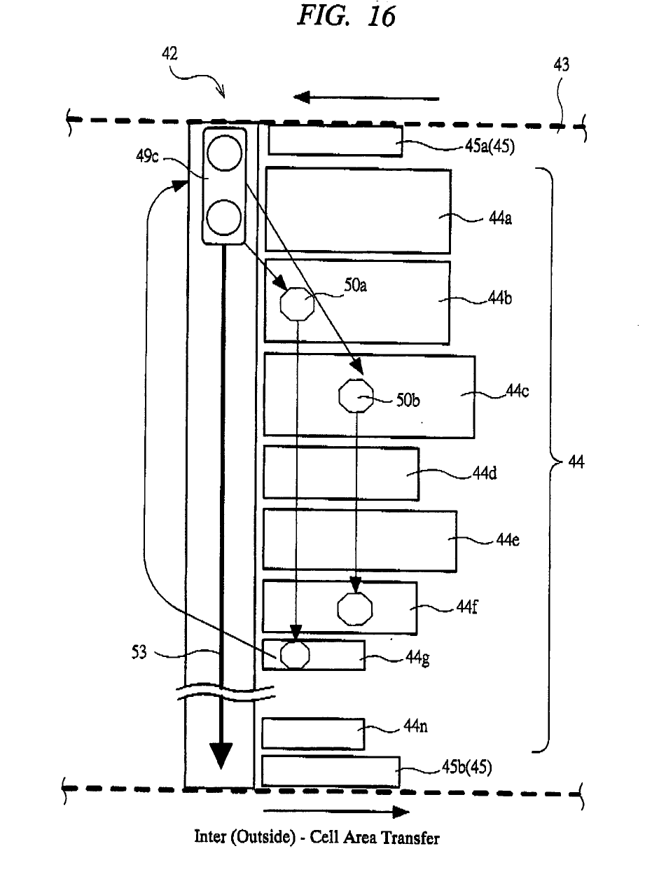

A transfer system (or conveyance system) of a present fifth embodiment has the same object as that of the third embodiment and has such a configuration that the transfer time in the direction extending along the process flow in the cell area employing the flow shop system layout becomes the shortest time. As shown in FIG. 16, in the configuration having the flow shop area (cell area 43) and the guided vehicles 49, the vehicle 49c can carry a plurality of products 50 (50a and 50b) (in the Figure, two wafer cassettes), wherein the guided vehicle can carry a second product 50b as well as a first product 50a during transfer of the first product 50a.

Therefore, in the transfer operation of the transfer system according to the present embodiment, for example, the guided vehicle 49c which can convey two wafer cassettes is placed in the standby condition at the upstream portion on the transfer path 53 until a transfer instruction is given. When the transfer instruction is given, the guided vehicle 49c moves to the corresponding manufacturing apparatus 44b which is a processing apparatus or inspection apparatus, delivers the first product 50a thereto, and returns to the upstream portion after the completion of the transfer and is placed in the standby condition. If a next transfer instruction is given during the transfer of the first product 50a, the guided vehicle 49c moves to the corresponding manufacturing apparatus 44c and delivers the second product 50b.

Therefore, according to the present embodiment, since the guided vehicle 49c can carry the plurality of products 50a and 50b and carry the second product 50b as well as the first product 50a during the transfer of the first product 50a, efficiency of the transfer performed by the guided vehicle 49c can be improved, whereby this leads to shortening of the cycle time for manufacturing the semiconductor products.

### Sixth Embodiment

A transfer system (or conveyance system) of a present sixth embodiment has such a configuration that there is provided in the cell area a keeping shelf for temporarily keeping a product in the vicinity of a currently used manufacturing apparatus and a manufacturing apparatus used in the next step when the product cannot be conveyed from the currently used manufacturing apparatus to the manufacturing apparatus used in the next step.

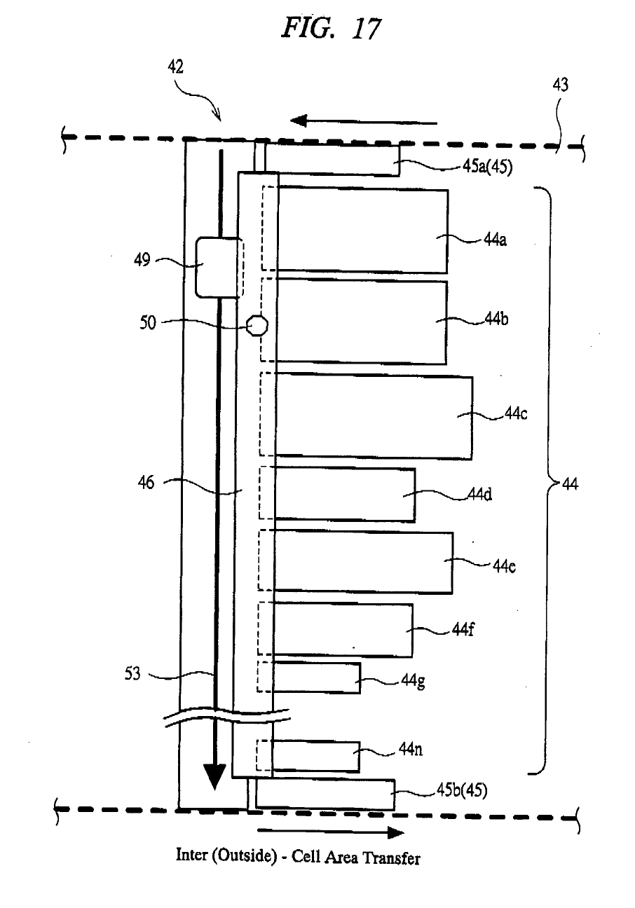

As shown in FIG. 17, the transfer system of the present embodiment has the flow shop area 42 and the guided vehicle 49 and, in such a configuration that the flow shop area 42 is divided into the cell areas 43, a keeping shelf 46 different from the station 45 is provided at the upper portion of the manufacturing apparatuses 44 which are the processing apparatuses or inspection apparatuses in the cell area 43.

Therefore, in the transfer operation of the transfer system of the present embodiment, when the guided vehicle 49 cannot immediately perform transfer to the manufacturing apparatus 44b of the next step for some reason, for example, for the reason that all the ports of the manufacturing apparatus 44b of the next step are occupied, the guided vehicle 49 temporarily keeps the product 50 in the keeping shelf 46 provided at the upper portion of the manufacturing apparatus 44, is temporarily placed in the standby condition in the vicinity of the keeping shelf 46, in which the product 50 is temporarily kept, without returning to the upstream portion. A soon as the manufacturing apparatus of the next step becomes-unoccupied, the guided vehicle 49 takes out the product 50 from the keeping shelf 46 and conveys the product to the manufacturing apparatus of the next step.

Therefore, according to the present embodiment, the keeping shelf 46 is provided at the upper portion of the manufacturing apparatus 44, so that when the transfer to the manufacturing apparatus 44 of the next step cannot be performed, the transfer time of the product 50 can be shortened by temporarily keeping the product 50 in the keeping shelf 46 and the wait time of the guided vehicle 49 can also be shortened. Accordingly, this leads to shortening of the cycle time for manufacturing the semiconductor products.

### Seventh Embodiment

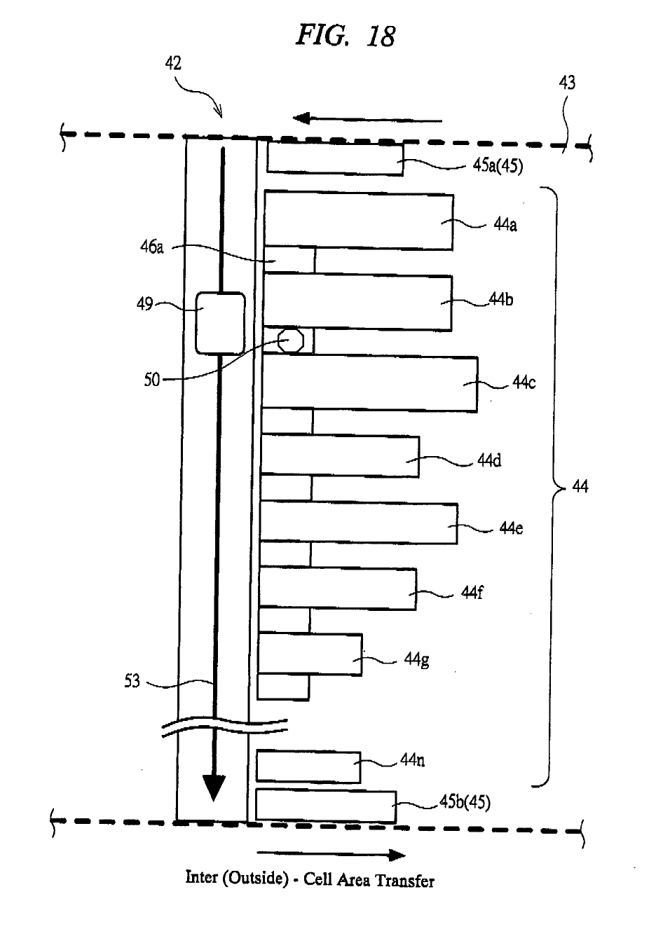

A transfer system (or conveyance system) of a present embodiment has the same object as that of the above-described sixth embodiment, and has such a configuration that keeping shelves for temporarily keeping the products are provided in the cell area, wherein as shown in FIG. 18, the keeping shelves 46a are provided between the manufacturing apparatuses 44.

Therefore, the transfer operation of the transfer system according to the present embodiment is performed similarly to that in the above-described sixth embodiment, so that the present embodiment can obtain the same effects as those of the above-described sixth embodiment.

### Eighth Embodiment

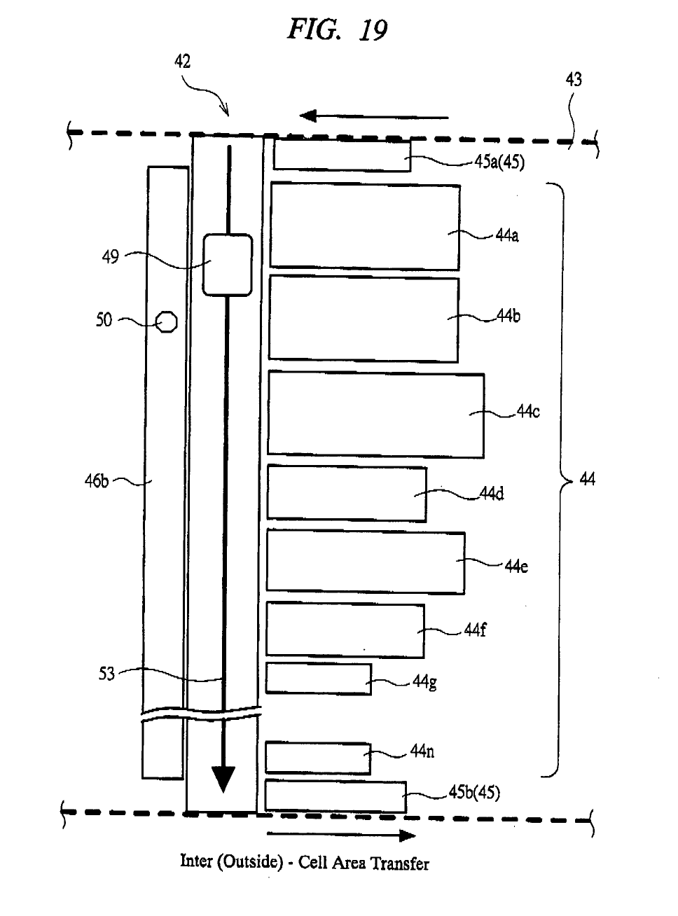

A transfer system (or conveyance system) of a present embodiment has the same object as that of the above-described sixth embodiment, and has such a configuration that a keeping shelf for temporarily keeping the products is provided in the cell area. As shown in FIG. 19, a keeping shelf 46b is provided on a opposite side to the manufacturing apparatuses 44.

Therefore, the transfer operation of the transfer system according to the present embodiment is performed similarly to that of the above-described sixth embodiment, so that the present embodiment can obtain the same effects as those of the above-described sixth embodiment.

### Ninth Embodiment

A transfer system (or conveyance system) of a present embodiment has such a configuration that other cell areas employing the same type of the flow shop system layout are further disposed next to or in the vicinity of the cell area employing the flow shop system layout, whereby delivery of the product between the cell areas can be smoothly performed.

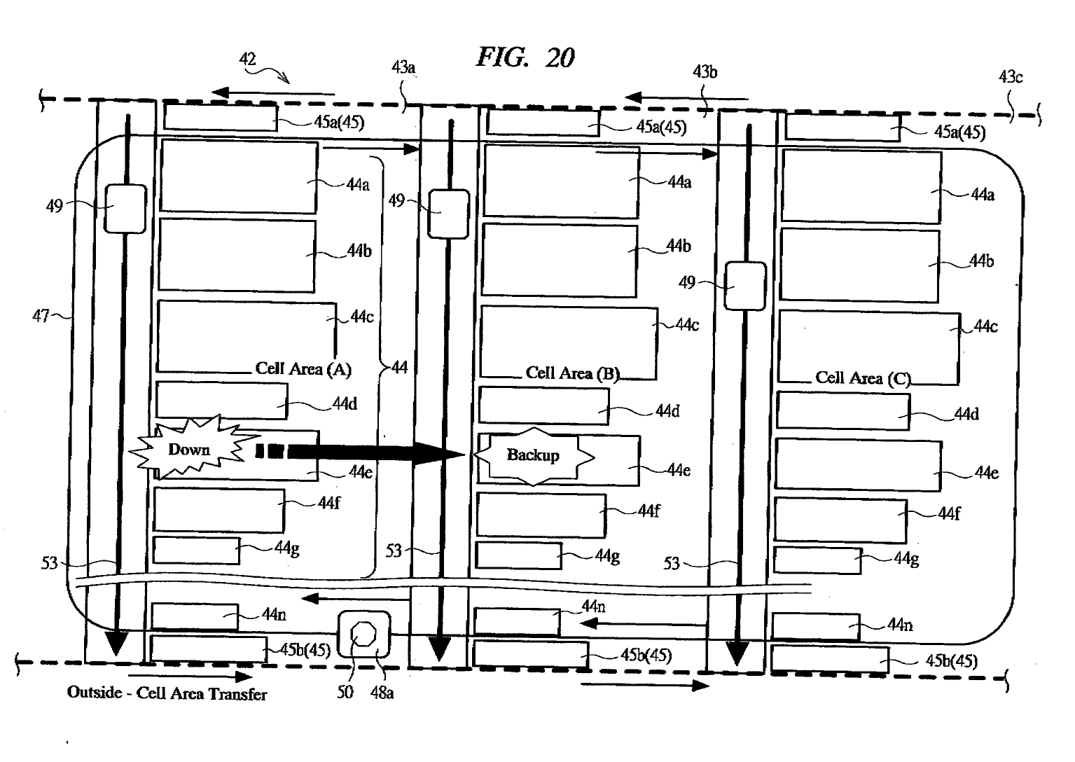

As shown in FIG. 20, the transfer system according to the present embodiment has the flow shop area 42 and the guided vehicles 49 and has such a configuration that the flow shop area 42 is divided into cell areas 43 (cell areas (A) 43a, (B) 43b, and (C) 43c), wherein a transfer path 47 for transferring the product 50 via the stations 45 is provided over the plurality of cell areas 43.

That is, the transfer path 47 dedicated for sharing the stations 45 is provided in addition to the transfer system which includes the transfer for moving from one cell area to other cell area along the process flow, the transfer for moving from one cell area to other job shop area, or the inverted transfer for moving from the other job shop area to the one cell area.

In the dedicated transfer path 47, a guided vehicle 48 such as an OHT or OHS is employed, and Is provided so as to go around the respective stations 45a and 45b which are disposed at the upstream and downstream portions of each of the cell areas 43a to 43c. Note that since each of the stations 45a and 45b is shared with the above-described other types of transfer in addition to the transfer path 47 dedicated for inter-cell area transfer, the inside of each of the stations 45a and 45b is dedicated for inter-cell area transfer and the outside thereof is used for the intra-cell area transfer.

Therefore, a transfer operation of the transfer system according to the present embodiment will be described as follows, for example, in the case where a fifth manufacturing apparatus 44e which is a processing apparatus or inspection apparatus for performing a predetermined process in the cell area (A) 43a is downs a backup process is executed by another fifth manufacturing apparatus 44e which is in the cell area (B) 43b and performs the same process or inspection as that of the down fifth manufacturing apparatus 44e.

First, in the cell area (A) 43a, when the process or inspection by the fourth manufacturing apparatus 44d which performs a step preceding to that of the down fifth manufacturing apparatus 44e is completed, the guided vehicle 49 receives the product 50 from the fourth manufacturing apparatus 44d, and keeps it in the downstream station 45b on the transfer path 53. Then, the guided vehicle 48 dedicated for the inter-cell area transfer receives the product 50 from the downstream station 45b in the cell area (A) 43a, conveys the product 50 to the upstream station 45a in the cell area (B) 43b via the transfer path 47 dedicated for the inter-cell area transfer, and keeps the product therein.

Then, in the cell area (B) 43b, the guided vehicle 49 in the cell area receives the product 50 from the upstream station 45a on the transfer path 53, and conveys the product to other fifth manufacturing apparatus 44e which performs the same process or inspection as that of the down fifth manufacturing apparatus 44e. Then, when the process or inspection by the other fifth manufacturing apparatus 44e is completed, the guided vehicle 49 in the cell area receives the product 50 from the other fifth manufacturing apparatus 44e, and keeps the product in the downstream station 45b.

Subsequently, the guided vehicle 48 dedicated for the inter-cell area transfer receives the product 50 from the downstream station 45b in the cell area (B) 43b, conveys the product 50 to the upstream station 45a in the cell area (A) 43a through the transfer path 47 dedicated for the inter-cell area transfer, and keeps the product therein. Thereafter, in the cell area (A) 43a, the guided vehicle 49 in the cell area again conveys the product 50 in order to execute the predetermined processes or inspections to the product sequentially from a sixth manufacturing apparatus 44f which performs a step subsequent to that of the down fifth manufacturing apparatus 44e.

Therefore, according to the present embodiment, the transfer path 47 for conveying the product 50 via the stations 45 is provided over the plurality of cell areas 43, so that when a manufacturing apparatus 44 in a certain cell area 43 is down and a backup process is performed by other manufacturing apparatus 44 which performs the same process or inspection in other cell area 43, delivery of the product 50 between the cell areas 43 can be smoothly performed. As a result, the transfer time and the transfer distance of the product 50 can be shortened, whereby this leads to shortening of the cycle time for manufacturing the semiconductor products.

### Tenth Embodiment

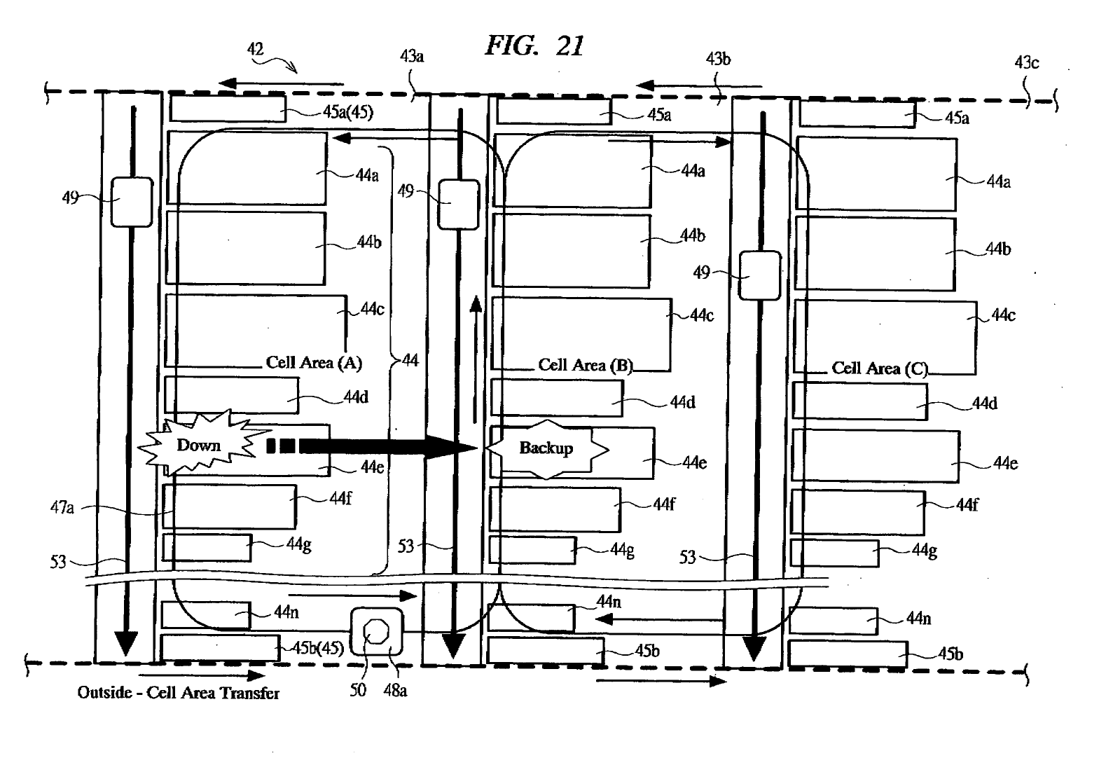

A transfer system (or conveyance system) of the present embodiment has the same object as that of the above-described ninth embodiment, and has such a configuration that other cell areas employing the same type of the flow shop system layout are further disposed next to or in the vicinity of the cell area employing the flow shop system layout, whereby the delivery of the product between the cell areas can be smoothly performed. As shown in FIG. 21, the transfer system has the flow shop area 42 and the guided vehicle 49 and has a structure in which the flow shop area 42 is divided into the cell areas 43 (cell areas (A) 43a, (B) 43b, and (C) 43c) and a transfer path 47a for conveying the product 50 from the manufacturing apparatuses in first cell area to the manufacturing apparatuses in the second cell area is provided over the plurality of cell areas 43.

Therefore, in a transfer operation of the transfer system according to the present embodiment similarly to the above-described ninth embodiment, in view of the case where the fifth manufacturing apparatus 44e which has the down processing or inspection apparatus in the cell area (A) 43a is subjected to a backup process by the fifth manufacturing apparatus 44e in the cell area (B) 43b, a guided vehicle 48a dedicated for the inter-cell area transfer receives the product 50 from the fourth manufacturing apparatus 44d after the process or inspection of the fourth manufacturing apparatus 44d, which is in the cell area (A) 43a and performs a step preceding to that of the down fifth manufacturing apparatus 44e, is completed. The guided vehicle 48a transfers the product 50, directly to the fifth manufacturing apparatus 44e which is in the cell area (B) 43b and performs the same process or inspection as that of the down fifth manufacturing apparatus 44e, through the transfer path 47a dedicated for the inter-cell area transfer.

Therefore, according to the present embodiment, since the transfer path 47a for conveying the product 50 directly between the manufacturing apparatuses 44 of different cell areas is provided over the plurality of cell areas 43, the same effects as those of the ninth embodiment can be obtained.

In the present embodiment, the transfer path 47a provided over the plurality of cell areas 43 can be also used as a path for conveying the product 50 within each of the cell areas 43 in addition to the transfer between the cell areas 43. For example, the guided vehicle such as an OHT or OHS is shared with the inter-cell area transfer and the intra-cell area transfer for use. In this case, as described above, the guided vehicle can be used in order to back up the manufacturing apparatus and, in addition to this, the guided vehicle can be used in order to perform the backup process when the transfer of the product within the cell area is halted due to, for example, maintenance or trouble, and the guided vehicle can be used in order to complement the transfer ability of the product within the cell area.

Each of the techniques of the above-described third to tenth embodiments can be individually applied, and in addition to this, the techniques can be applied in an arbitrary combination in order to realize further good efficient transfer.

The transfer techniques of the present invention can also be applied to, for example, a transfer system employing a flow shop system layout in which a plurality of manufacturing apparatuses are disposed along the flow of processes, and a transfer system employing a layout including a combination of, for example, a job shop system and a flow shop system wherein the plurality of manufacturing apparatuses are disposed based on the function of processes, Particularly, the above techniques can be suitably applied to semiconductor manufacturing systems employing the above-described transfer systems, and can be applied to a manufacturing system available to a general manufacturing industry.

As described above, the invention made by the inventors has been specifically described based on the embodiments. However, needless to say, the present invention is not limited to the above embodiments and can be variously modified and altered within departing from the gist thereof.

1. A semiconductor manufacturing system having a job shop section in which a group of manufacturing apparatuses with the same functions is disposed, and a flow shop section in which manufacturing apparatuses are sequentially disposed so as to corresponding to order of steps of manufacturing a semiconductor device, the semiconductor manufacturing system comprising the flow shop section including:
a quasi flow shop section in which the manufacturing apparatuses having almost the same level to a production balance condition of semiconductor manufacture are disposed approximately in order of the manufacturing steps; and
a quasi job shop section in which the manufacturing apparatuses, which are not included in the quasi flow shop section among the manufacturing apparatuses disposed in the flow shop section, are disposed.

2. The semiconductor manufacturing system according to claim 1,
wherein the production balance condition of the flow shop section is at least one item selected from among a processing ability, a maintenance frequency, a maintenance time, a failure frequency, and a repair time of each of the manufacturing apparatuses.

3. The semiconductor manufacturing system according to claim 1,
wherein the quasi job shop section is provided so as to be adjacent to the job shop section and the quasi flow shop section.

4. The semiconductor manufacturing system according to claim 1,
wherein the manufacturing apparatuses disposed in the quasi flow shop comprises two or more divided quasi flow shops, each of which is divided per manufacturing apparatus group of a minimum unit required in the semiconductor manufacturing steps.

5. The semiconductor manufacturing system according to claim 1,
wherein the manufacturing apparatuses disposed in the quasi flow shop are used in at least one step of an ion implantation step and a wiring step among the semiconductor manufacturing steps.

6. The semiconductor manufacturing system according to claim 1,
wherein each of the manufacturing apparatuses in the quasi flow shop section is disposed so that a manufacturing step line becomes linear.

7. The semiconductor manufacturing system according to claim 1,
wherein each of the manufacturing apparatuses in the quasi flow shop section is disposed so that a manufacturing step line has a U shape.

8. The semiconductor manufacturing system according to claim 1,
wherein each of the manufacturing apparatuses in the quasi flow shop section is disposed based on utilities required by the manufacturing apparatuses in a manufacturing step line.

9. A work manufacturing system comprising:
a job shop area in which a group of manufacturing apparatuses with the same function is disposed; and
a flow shop area in which a plurality of manufacturing apparatuses are sequentially disposed so as to correspond to order of manufacturing steps of a work,
wherein the flow shop area includes:
a quasi flow shop area in which manufacturing apparatuses having almost the same level to a production balance condition of work manufacture are disposed approximately in order of manufacturing steps; and
a quasi job shop area in which the manufacturing apparatuses, which are not included in the quasi flow shop area among the manufacturing apparatuses disposed in the flow shop area, are disposed.

10. The work manufacturing system according to claim 9,
wherein the production balance condition of the flow shop area is at least one item selected from among a processing ability, a maintenance frequency, a maintenance time, a failure frequency, and a repair time of each of the manufacturing apparatuses.

11. A work manufacturing system comprising:
a first manufacturing area in which a group of manufacturing apparatuses having the same function is disposed; and
a second manufacturing area in which a plurality of manufacturing apparatuses are subsequently disposed so as to correspond to order of manufacturing steps of a work,
wherein the second manufacturing area includes:
a first apparatus set area in which manufacturing apparatuses having almost the same level to a production balance condition of work manufacture are sequentially disposed approximately in order of manufacturing steps; and
a second apparatus set area in which the manufacturing apparatuses, which are not included in the first apparatus set area among the manufacturing apparatuses disposed in the second manufacturing area, are sequentially disposed in order of the manufacturing steps.

12. The work manufacturing system according to claim 11,
wherein the production balance condition of the second manufacturing area is at least one item selected from among a processing ability, a maintenance frequency, a maintenance time, a failure frequency, and a repair time of each of the manufacturing apparatuses.

13. A semiconductor manufacturing system comprising:
a job shop in which a group of manufacturing apparatuses having the same function is disposed; and
a flow shop in which manufacturing apparatuses are sequentially disposed so as to correspond to order of steps of manufacturing a semiconductor device,
wherein the flow shop includes:
a quasi flow shop in which manufacturing apparatuses having the same level to a production balance condition of semiconductor manufacture are disposed approximately in order of manufacturing steps; and
a quasi job shop in which the manufacturing apparatuses, which are not included in the quasi flow shop among the manufacturing apparatuses disposed in the flow shop, are disposed,
the quasi flow shop includes two or more cells, each of which is composed of a manufacturing apparatus serving as a minimum unit required in a semiconductor manufacturing step, and
each cell is equipped with a manufacture management means for managing the cell as an independent manufacturing line.

14. The semiconductor manufacturing system according to claim 13,
wherein the intra-cell manufacture management means comprises:
an intra-cell apparatus integrator for individually controlling the manufacturing apparatuses disposed in the quasi flow shop;
an intra-cell transfer integrator for controlling an intra-cell transfer for conveying a semiconductor wafer between the manufacturing apparatuses; and
a cell host computer for executing control over the intra-cell apparatus integrator and the intra-cell transfer integrator.

15. The semiconductor manufacturing system according to claim 14, further comprising:
a host computer for executing control over the cell host computer provided in each of the cells.

16. The semiconductor manufacturing system according to claim 15,
wherein the host computer executes control so as to search, when the manufacturing apparatus in any one of the cells is not accepted, the manufacturing apparatus that is of the same type and is capable of performing a substitute process in other cells, and execute the substitute process by the searched manufacturing apparatus.

17. The semiconductor manufacturing system according to claim 13,
wherein the intra-cell manufacture management means is provided with an interface terminal serving as an interface with the cell host computer, and
the interface terminal is capable of controlling all the manufacturing apparatuses in each of the cells via the cell host computer.

18. The semiconductor manufacturing system according to claim 17,
wherein the interface terminal is provided with a recognition means for canceling an operational limitation of the manufacturing apparatus in each of the cells when availability information preliminarily set is inputted.

19. The semiconductor manufacturing system according to claim 14,
wherein the cell host computer calculates a production volume in the cell by accumulating the number of wafers processed by the manufacturing apparatuses in the cell.

20. The semiconductor manufacturing system according to claim 14,
wherein the cell host computer calculates a cycle time from a process starting time and a process completion time of the manufacturing apparatuses in the cell.

21. The semiconductor manufacturing system according to claim 13,
wherein the production balance condition of the flow shop is at least one item selected from among a processing ability, a maintenance frequency, a maintenance time, a failure frequency, and a repair time of each of the manufacturing apparatuses.

22. A work manufacturing system comprising:
a job shop in which a group of manufacturing apparatuses having the same function is disposed; and
a flow shop in which manufacturing apparatuses are sequentially disposed so as to correspond to order of steps of manufacturing a work,
wherein the flow shop includes;
a quasi flow shop in which the manufacturing apparatuses having almost the same level to a production balance condition of work manufacture are disposed approximately in order of manufacturing steps; and
a quasi job shop in which the manufacturing apparatuses, which are not included in the quasi flow shop among the manufacturing apparatuses disposed in the flow shop, are disposed, and
the quasi flow shop includes:
two or more cells, each of which is divided per manufacturing apparatus serving as a minimum unit required in the work manufacturing steps; and
an intra-cell manufacture management means for managing each of the cells as an independent manufacturing line, each of the cells being provided with the intra-cell manufacture management means.

23. A work manufacturing system comprising:
a first manufacturing area in which a group of manufacturing apparatuses having the same function is disposed; and
a second manufacturing area in which a plurality of manufacturing apparatuses are subsequently disposed so as to correspond to order of manufacturing steps of a work,
wherein the second manufacturing area includes:
a first apparatus set area in which manufacturing apparatuses having almost the same level to a production balance condition of work manufacture are sequentially disposed approximately in order of manufacturing steps; and
a second apparatus set area in which the manufacturing apparatuses, which are not included in the first apparatus set area among the manufacturing apparatuses disposed in the second manufacturing area, are disposed, and
wherein the first apparatus set area includes two or more cells, each of which is composed of a manufacturing apparatus serving as a minimum unit required in a semiconductor manufacturing step, and
each cell is equipped with a manufacture management means for managing the cell as an independent manufacturing line.

24. A transfer system comprising:
a flow shop area in which a plurality of manufacturing apparatuses are arranged along a process flow; and
a guided vehicle for conveying a product between the plurality of manufacturing apparatuses in the flow shop area,
wherein the guided vehicle has a driving wheel set at a rear-wheel side and a decelerator set at a front-wheel side with respect to a transfer direction of the product.

25. A transfer system comprising:
a flow shop area in which a plurality of manufacturing apparatuses are disposed along a process flow; and
a guided vehicle for conveying a product between the plurality of manufacturing apparatuses in the flow shop area,
wherein the guided vehicle is placed in a standby condition at a upstream portion with respect to a transfer direction of the product.

26. A transfer system comprising:
a flow shop area in which a plurality of manufacturing apparatuses are disposed along a process flow; and
a plurality of guided vehicles for conveying a product between the plurality of manufacturing apparatuses in the flow shop area,
wherein the plurality of guided vehicles move on one rail and are placed in standby conditions at a upstream portion in a transfer direction of the product.

27. A transfer system comprising:
a flow shop area in which a plurality of manufacturing apparatuses are disposed along a process flow; and
a guided vehicle for conveying a product between the plurality of manufacturing apparatuses in the flow shop area,
wherein the guided vehicle is capable of conveying a plurality of products, and conveying a second product as well as a first product during transfer of the first product.

28. A transfer system comprising:
a flow shop area in which a plurality of manufacturing apparatuses are disposed along a process flow; and
a guided vehicle for conveying a product between the plurality of manufacturing apparatuses in the flow shop area,
wherein the flow shop area is divided into a cell area composed of a group of manufacturing apparatuses serving as a minimum unit required in a step, and
a keeping shelf for temporarily keeping the product is provided in the cell area, near a currently used manufacturing apparatus and a manufacturing apparatus used in a next step, when the product cannot be conveyed from the currently used manufacturing apparatus to the manufacturing apparatus used in the next step.

29. A transfer system comprising:
a flow shop area in which a plurality of manufacturing apparatuses are disposed along a process flow; and
a guided vehicle for conveying a product between the plurality of manufacturing apparatuses in the flow shop area,
wherein the flow shop area is divided into a plurality of cell areas, each of which is composed of a group of manufacturing apparatuses serving as a minimum unit required in a step, and
a transfer path for conveying the product is provided over the plurality of cell areas.
